(19) United States
(12) Patent Application Publication
(10) Pub. No.: US 2012/0266094 A1
(43) Pub. Date: Oct. 18, 2012

(54) Monitoring Process Control System

(76) Inventors: Kevin Dale Starr, Lancaster, OH (US); Timothy Andrew Mast, Plain City, OH (US)

(21) Appl. No.: 13/088,001

(22) Filed: Apr. 15, 2011

(51) Int. Cl. G06F 3/048

(52) U.S. Cl. 715/771

(57) ABSTRACT

A system includes an identification component configured to identify a set of key performance indicators that fail to satisfy predetermined acceptance criteria based on acquired performance data, where the set of key performance indicators is indicative of performance of components of a process control system. The system further includes a visualization component configured to visually present the identified set of key performance indicators, the components, and the acquired performance data in a graphical user interface displayed via a monitor. The system further includes a manual override component configured to allow a user to manually override and modify the information presented by the graphical user interface based, at least in part, on the acquired performance data.

### TECHNICAL FIELD OF THE INVENTION

The following general relates to process control systems and more particularly to monitoring process control systems.

### BACKGROUND

A simple process control system may include a few (e.g., four) modules. A technician or the like can access these modules individually to gather information related to performance of the simple process control system. The technician can analyze and synthesize this information to determine system performance. Based on this analysis and synthesis, the technician can diagnosis system errors, determine system components that should be corrected, etc.

More complex process control systems generally include more modules (e.g., 400), and it can take the technician much longer to gather, analyze, and synthesize the information. Furthermore, it can be more time consuming and difficult for the technician to diagnosis system errors, determine system components that should be corrected, etc. More complex process control systems may also require a technician with more experience and/or expertise.

Automated approaches have also been used. With such approaches, a computer determines and evaluates performance related data such as Key Performance Indicators (KPIs). The computer can identify components needing user attention based on the KPIs and present information about the components and the KPIs to the user. While automatic approaches have been beneficial, oftentimes the results turn out to be not very useful to the user. For example, the computer may indicate a component is not performing satisfactorily when the component is actually performing satisfactorily (a false positive). This may lead to the user ignoring evaluation results, and not attending to a component that actually is performing unsatisfactorily.

In view of at least the foregoing, there is an unresolved need for other approaches to monitoring process control systems.

### SUMMARY

Aspects of the present application address these matters, and others.

According to one aspect, a system includes an identification component configured to identify a set of key performance indicators that fail to satisfy predetermined acceptance criteria based on acquired performance data, where the set of key performance indicators is indicative of performance of components of a process control system. The system further includes a visualization component configured to visually present the identified set of key performance indicators, the components, and the acquired performance data in a graphical user interface displayed via a monitor. The system further includes a manual override component configured to allow a user to manually override and modify the information presented by the graphical user interface based, at least in part, on the acquired performance data.

According to another aspect, a method includes evaluating a set of data from a process control system. The method also includes determining how to configure a graphical user interface based, at least in part, on the evaluation. The method further includes creating the graphical user interface, where the graphical user interface visually presents information indicative of a performance of the process control system.

According to yet another aspect, a system includes an identification component configured to identify a set of key performance indicators indicative of the performance of a process control system that does not meet a desired result. The system can also include a determination component configured to determine a priority level order for individual key performance indicators of the set of key performance indicators. The system can further include a generation component configured to generate a graphical user interface, where the graphical user interface indicates individual key performance indicators of the set of key performance indicators according to the priority level order and where the graphical user interface indicates a performance level of an individual key performance indicator. In addition, the system can include a manual override component configured to enable a manual modification of the graphical user interface such that performance level of the individual key performance indicator is changed (e.g., changed from an acceptable performance level to an unacceptable performance level or changed from an unacceptable performance level to an acceptable performance level).

Those skilled in the art will appreciate still other aspects of the present application upon reading and understanding the attached figures and description.

### FIGURES

The present application is illustrated by way of example and not limitation in the figures of the accompanying drawings, in which like references indicate similar elements and in which:

FIG. 1 schematically illustrates an example system for visually presenting information indicative of a performance of a process control system;

FIG. 2 schematically illustrates an example of a harmony system that functions as a process control system;

FIG. 3 schematically illustrates an example storage system;

FIG. 4 illustrates an example GUI that presents a system grouping and trend plot;

FIG. 5 illustrates an example GUI that facilitates custom grouping;

FIG. 6 illustrates an example GUI for a manually creating a group;

FIG. 7 illustrates an example GUI that presents results for use in building groups;

FIG. 8 illustrates an example GUI that uses manual numerical index grouping by a user;

FIG. 9 illustrates an example GUI that facilitates entity searching;

FIG. 10 illustrates an example GUI that facilitates user selection of performance data;

FIG. 11 illustrates an example GUI that facilitates zooming;

FIG. 12 illustrates an example GUI of analysis trend options;

FIG. 13 illustrates an example GUI that includes statistical table results;

FIG. 14 illustrates an example GUI that facilitates user entity sorting;

FIG. 15 illustrates an example GUI with multiple windows;

FIG. 16 illustrates an example GUI that presents an entity property view;

FIG. 17 illustrates an example GUI that presents trend and numerical views;

FIG. 18 illustrates an example GUI that includes an XY trend plot;

FIG. 19 schematically illustrates an example of the visualization component;

FIG. 20 schematically illustrates an example of the process control system;

FIG. 21 illustrates an example of evaluation flow;

FIG. 22 illustrates an example GUI;

FIG. 23 illustrates an example GUI that presents key performance indicator information;

FIGS. 24A, 24B, and 24C illustrate example GUIs that report performance;

FIG. 25 illustrates an example GUI with a sorting portion and a definition portion;

FIG. 26 illustrates an example GUI with a pareto and trend portion and a filter portion;

FIG. 27 illustrates an example GUI that presents a performance summary by priority;

FIG. 28 illustrates an example table with default threshold values;

FIG. 29 illustrates an example GUI that presents spider chart summary statistics; and

FIG. 30 schematically illustrates an example of a system for automatic performance signal flow.

### DESCRIPTION

An entity such as a company, a manufacturer, or the like can employ a process control system (e.g., a Harmony process control system) to control one or more processing systems of the entity. The process control system can be fairly simple or highly complex, with many different hardware components, information sources, and the like. Information related to the process control system can be gathered by the process control system and visually presented by the process control system via a user-configurable interactive graphical user interface (GUI) for a user.

The presented information allows for quick understanding of a health or state of the industrial process control system, diagnosing problems with the industrial process control system, etc. As described in greater detail below, in one instance, the GUI presents one or more key performance indicators (KPIs), which can indicate performance of various component of the industrial process control system, along with data used to determine the KPIs. The user can, via the GUI, manually override the status of a KPI, request display of a KPI not already displayed, remove a displayed KPI from being displayed, and/or otherwise influence the presented information.

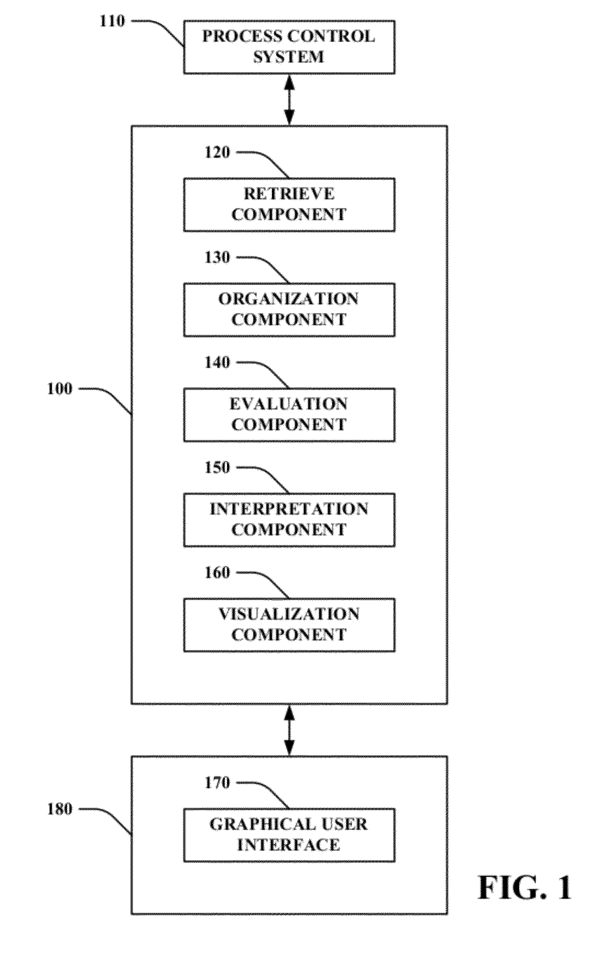

FIG. 1 illustrates an example system 100 for managing a process control system (PCS) 110. The system 100 includes a retrieve component 120 configured to retrieve information related to the process control system 110. This information can include raw performance information, notice information (e.g., notification if a component is operating in a desirable manner or not), etc.

An organization component 130 organizes the information obtained by the gather component 120. The organization component 130 can organize the information according to source (e.g., hierarchically sort information based on what physical unit provided the information), priority level, a customized rule-set (e.g., a user defined instruction set for organizing information), etc. The organization component 130 can retain this information in storage. For example, the information can be stored hierarchically according to a topology of the process control system 110. In this example, the process control system 110 can be divided into different loops, a loop can be divided into different nodes, and a node can be divided into different modules.

An evaluation component 140 evaluates the sorted information (e.g., a set of data) of the process control system 110 and produces evaluation result. For example, the evaluation component 140 can access storage that retains the organized information. The evaluation component 140 evaluates how a node is operating by determining performance of modules included in the node.

An interpretation component 150 interprets the information based, at least in part, on the evaluation result. For example, the interpretation component 150 can determine that a component of the process control system 110 does not satisfy predetermined acceptance criteria.

A visualization component 160 can generate data regarding the performance of the process control system 110 based on an interpretation and present the data in a graphical user interface (GUI) 170 presented via display screen or monitor 180. The visualization component 160 can determine data from the set of data that is considered high priority based, at least in part, on the evaluation result, where the GUI 170 highlights data considered high priority. For example, a major component not functioning correctly can be represented by a visual indicator such as an icon flashing red in the GUI 170.

In one embodiment, the retrieve component 120 retrieves information related to operation of a particular module of a particular loop. The sort component 130 organizes information related to operation of the particular module and the evaluation component 140 evaluates this information. The interpretation component 150 determines if the module is operating within predetermined operating parameters based, at least in part, on the evaluation. If the module is operating within the predetermined operating parameters, then the visualization component 160 presents information that indicates such. Otherwise, the visualization component 160 presents information that indicates the module is not operating within the predetermined operating parameters. In either instance, the information used to make the determination can also be displayed.

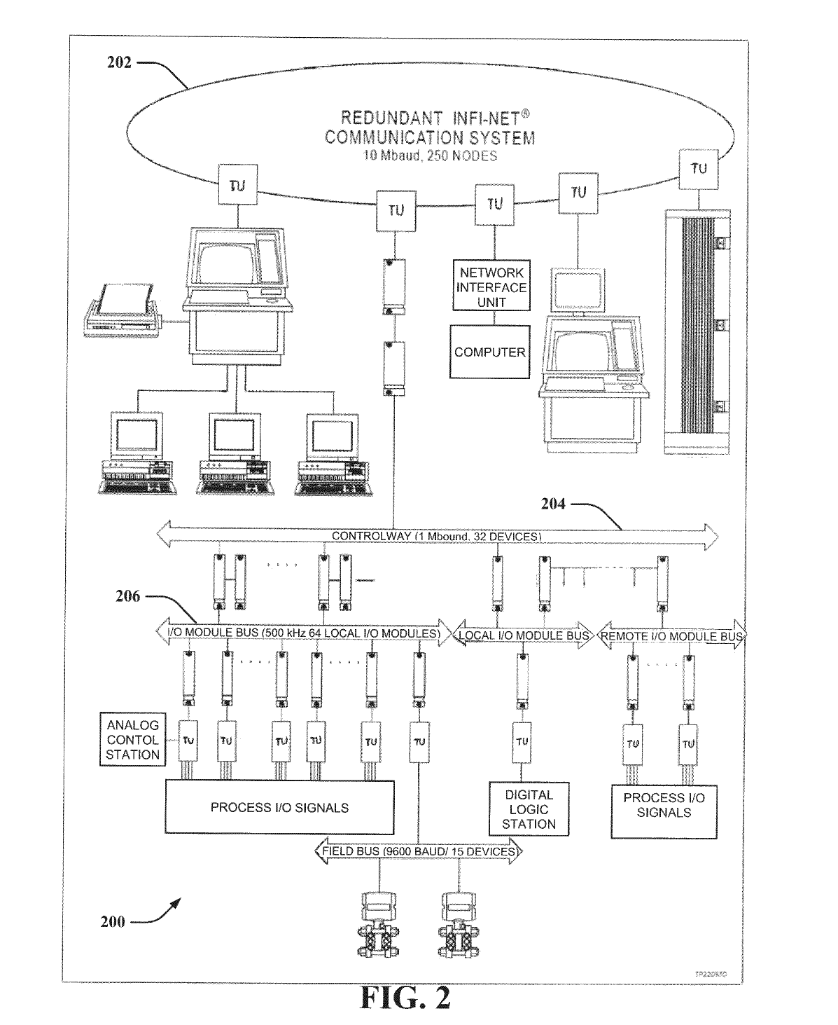

FIG. 2 illustrates an example system 200 monitored by the PCS 110. The illustrated system 200 is an example Bailey INFI 90 system, which is disclosed for explanatory purposes and is not limiting; it is to be appreciated that the system 200 may alternatively be another system.

In this example, there are three main regions in the Bailey INFI 90 system, an INFI-NET region 202, a CONTROLWAY region 204, and an I/O region 206. The INFI-NET region 202 (or ‘Superloop’) allows one node to communicate with another node. These nodes may be in a single control room, located throughout a plant, located remote from the plant, etc. A node may be an operator console, a set of modules (PCU) or an interface to some other hardware such as another INFI-NET or computer. INFI-NET topology generally consists of a central or supervisory loop and satellite loops, which are connected to a supervisory ring through a bridge or gateway node. A supervisory loop can be INFI-NET. Satellite loops may be INFI-NET or Plant Loop. The CONTROLWAY region 204 (or ‘Module Bus’) allows modules to communicate with other modules connected on the same bus. Controlway is a communications bus that is used between modules in the same PCU, whereas INFI-NET (Superloop) is used between different PCUs. The Controlway is a redundant, serial communication system, which uses an Ethernet-like protocol for passing data between modules in a Module Mounting Unit (MMU). The I/O region 206 (or ‘expander’) includes a bus that provides communication lines for the I/O modules to talk to an intelligent module. The I/O bus is the communications link between the field I/O and the controllers.

Time is synchronized on the supervisory and sub-rings at a predetermined synchronization update frequency and is accurate within a predefined tolerance. Synchronization takes into account the transmission delays through the active repeater nodes on each ring. Peer-to-peer communications is possible, which means that system-wide access to data is available: a node on the network can exchange data with another other node. This means that a field device's output, wired to a PCU in the plant, is available to a module in another PCU, if so configured. Data is transmitted between different nodes by a protocol that uses exception reports. That is, values are sent over the INFI-NET loop on an exception basis rather than on a continuous basis (polled). This results in more efficient use of the available bandwidth. Function Code Blocks (FCB) within the module(s) are used to define and access remote points.

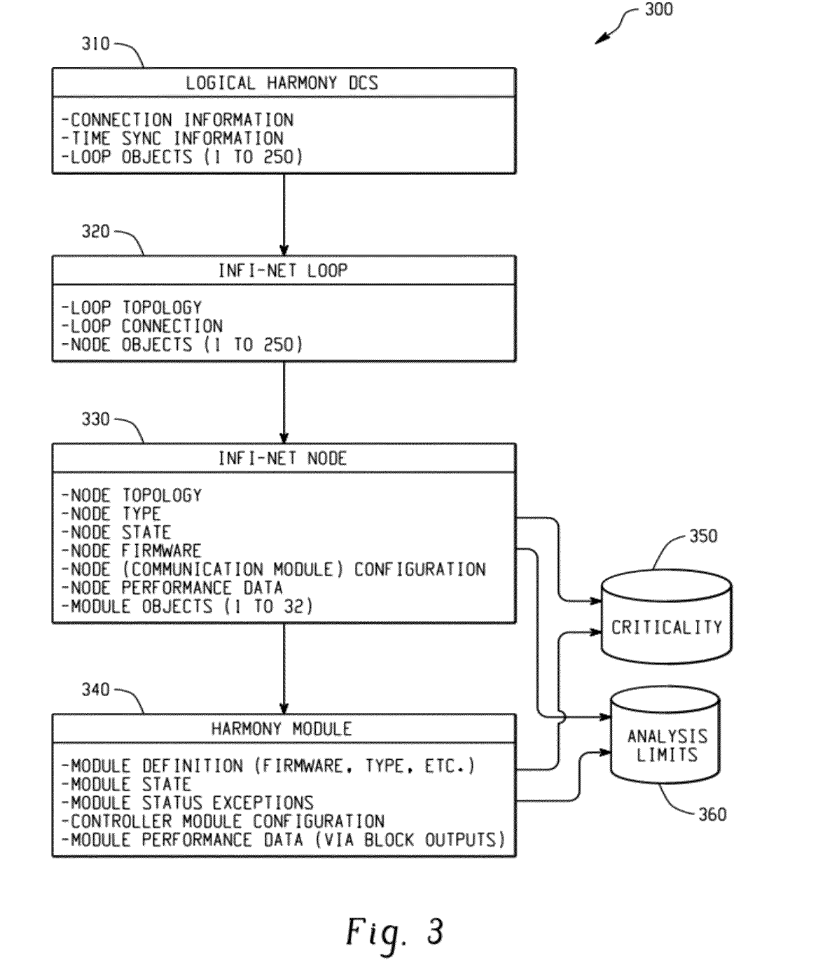

FIG. 3 illustrates an example system 300 for storing information produced by different components of a PCS, such as the PCS 110 that monitors the system 200 of FIG. 2. In the data gathering process (e.g., performed by the retrieve component 120 of FIG. 1) there can be at least two different file types that are tied together and utilized in the diagnostic process. The system 300 can store these different file types as well as store information that ties the file types together. In one example, a first level 310 retains information for the PCS 110 of FIG. 1 (e.g., the PCS 110 of FIG. 1 functioning as a distributed control system). Information can be divided down into a second level 320 of loop information, a third level 330 of node information, and a fourth level 340 of module information. Third level 330 and fourth level 340 information can be stored twice and organized twice (in different file types): once related to node/module criticality (e.g., at storage 350) and once related to analysis limits (e.g., at storage 360). An internal data model can be built from this stored information and grouped according system topology (e.g., topology of the process control system 110 of FIG. 1).

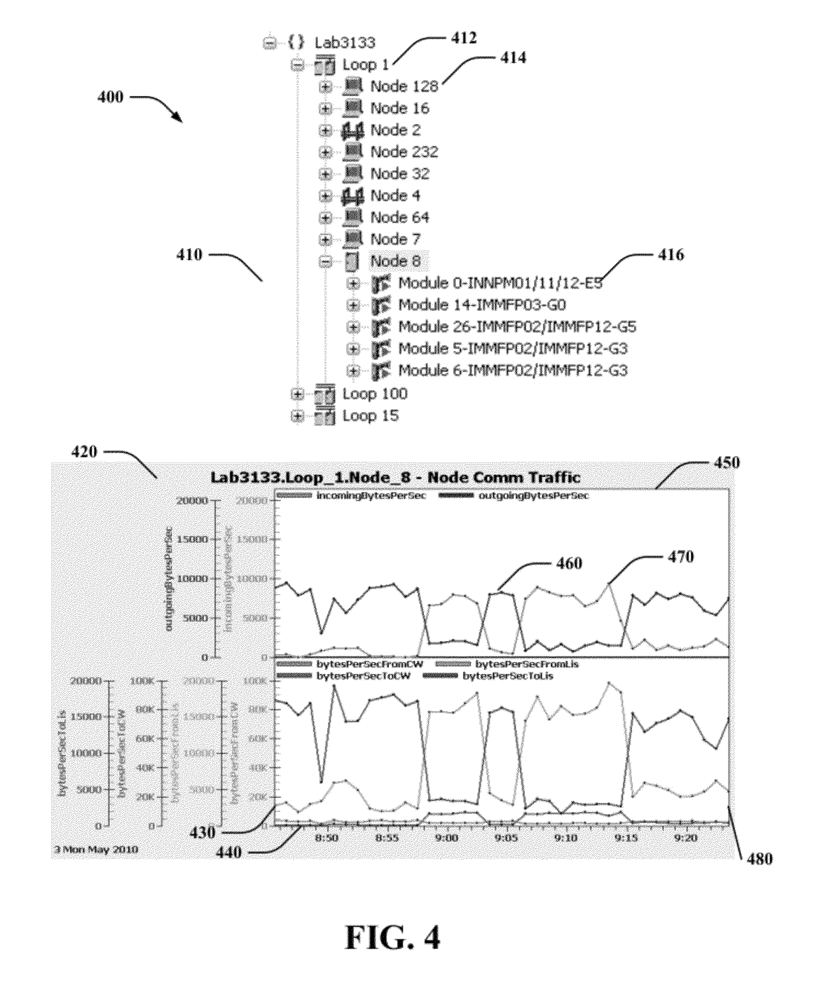

FIG. 4 illustrates example information that can be visually presented in the GUI 170. A first portion 400 visually represents a topology 410 of the process control system 110 of FIG. 1 in a hierarchical manner and includes various components such as loops 412, nodes 414, and modules 416. Different topology configurations can be used, such as communication order, address order, and others. The GUI 170 also visually presents a time-based trend of node performance data in a graph 420 (e.g., trend plot). In the graph 420, the y-axis 430 represents bytes. The x-axis 440 represents time. In the illustrated example, there are two windows, a first window 450 showing an incoming curve 460 and an outgoing curve 470 and a second window 480 with curves incoming and outgoing from different sources. The trend can have multiple y-axis that are stacked on top of each other, with each independently configurable as to what data should be displayed.

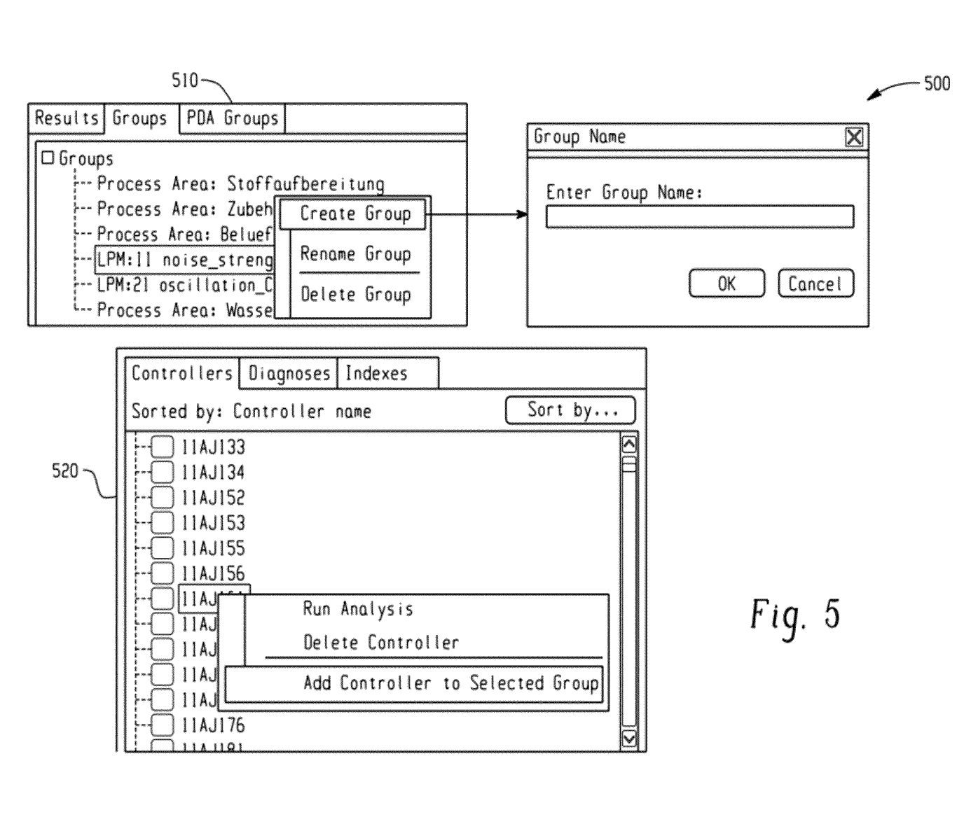

FIG. 5 illustrates various graphical menus 500 that facilitates manual visual identification grouping. In FIG. 4, components are automatically grouped together based on a default such as in a hierarchical manner. However, a user may want a different grouping. The user can use the graphical menus 500 to select an alternative grouping. In the illustrated embodiment, the menus 500 can include a group creation option 510 for creating a group and an add component to group option 520 for adding a component to a group. In this instance, once the group is created, the user can add entities into this group by navigating an entity list and selecting via a mouse click or otherwise over an entity of interest to bring up functionality to add the entity to the group. Once entities are added, the user can view the collection of entities for the group. Of course, groups and/or components in a group can also be removed.

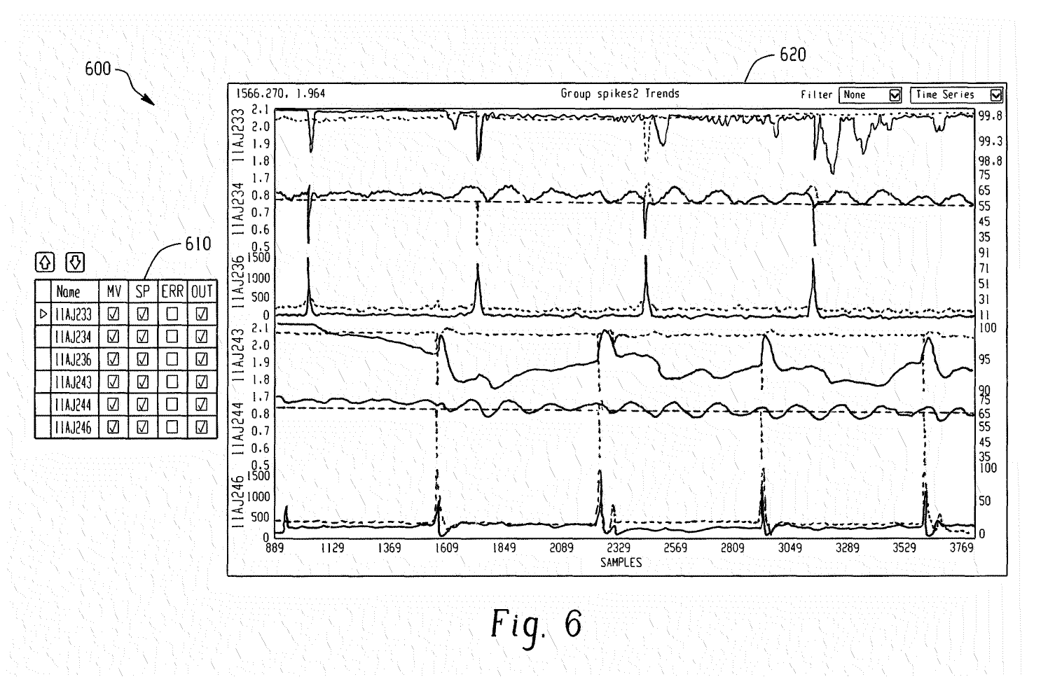

FIG. 6 illustrates an example of a GUI 600 showing a collection of controllers with spikes 610 and a trend plot 620 for a manually created group. In one embodiment, a user can desire to see how different controllers are functioning that are going through a purge cycle. The user can group these controllers together (as described in FIG. 5), and the GUI 600 shows how these controllers are operating. For example, the trend plot 620 shows six different controllers (e.g., 11AJ246) and how these individual controllers are performing at different samples. The GUI 600 can enable a user to be able to multi-task, such as by being able to evaluate multiple controllers at one time and make inferences from this evaluation. For example, at about sample 1600, three controllers are experiencing a spike while three other controllers are experiencing a spike at about 1700. Based on the common occurrences of these spikes, the user can draw inferences (e.g., certain controllers are experiencing a common problem, etc.).

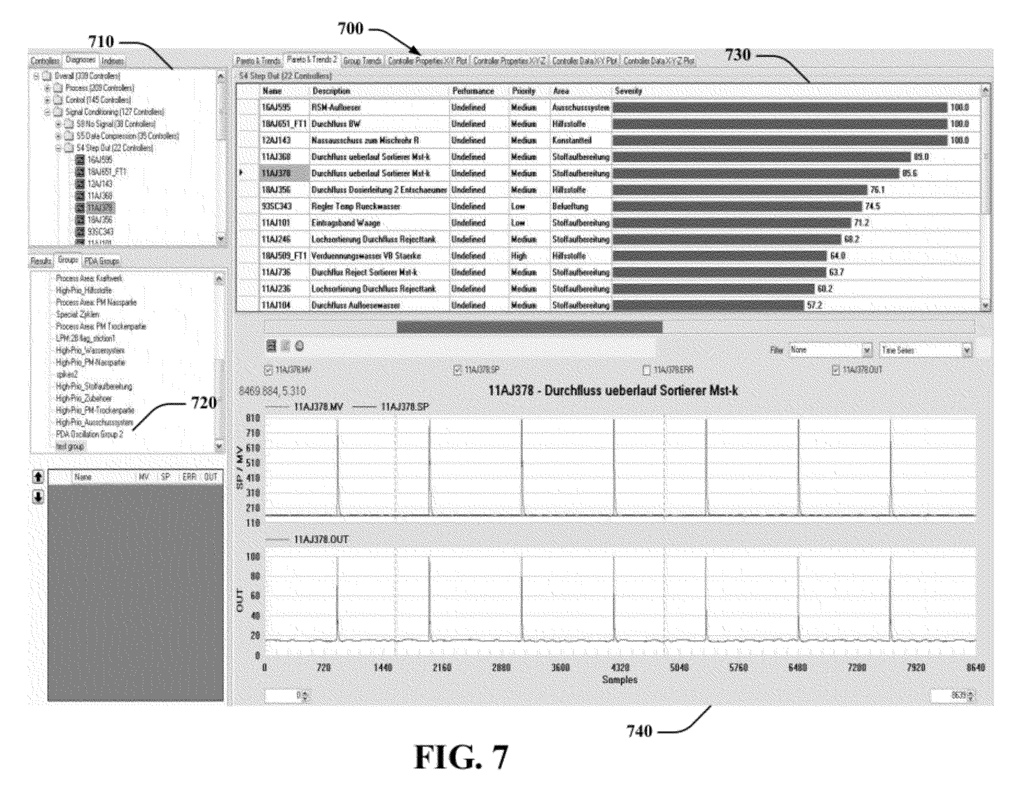

FIG. 7 illustrates a GUI 700 visually showing key performance indicator information. The illustrated GUI 700 includes multiple areas. A first area 710 shows a hierarchical organization of a process control system being evaluated. A second area 720 shows different groups that can be selected. These groups can be arranged automatically (e.g., by the system 100 of FIG. 1) or by a user (e.g., by using the menus 500 of FIG. 5). A third area 730 shows KPIs organized according to level of severity. A user can sort the KPIs according to other criteria, such as priority, description, etc. In a fourth area 740, a trend plot for one of the KPIs is presented. From this trend plot, the user can make determinations and diagnose the system associated with the KPI (e.g., the PCS 110 of FIG. 1). For example, the user can view the trend plot of the fourth area 740 and determine why a controller is not functioning as desired. Results of key performance indicators can be used as input for a collection of entities in a user-defined group. In other words, if a controller is experiencing a problem with a key performance indicator, this controller can be added to the user defined group for further diagnosis. For example, the user can add KPIs with a severity level 100 to a user defined group.

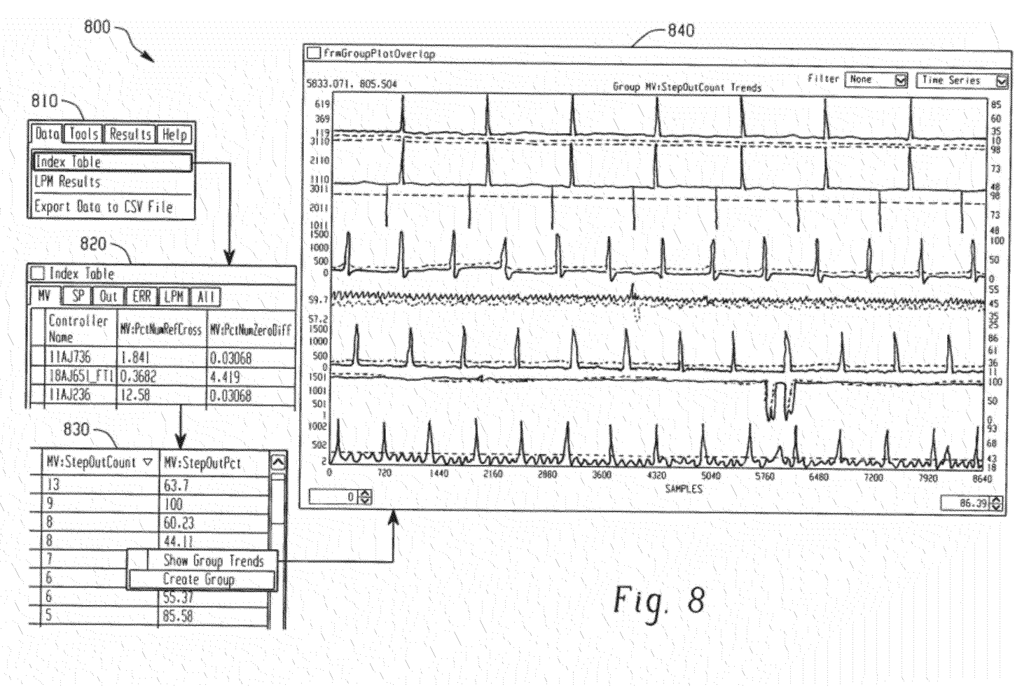

FIG. 8 illustrates an example of a GUI 800 that uses manual numerical index grouping by a user. The GUI 800 includes a taskbar 810 that enables the user to perform various tasks related to the GUI. For example, the taskbar 810 includes a tool section that provides various tools to the user. The taskbar 810 also includes a data section that enables the user to cause generation or bring up a previously stored index table. Results used to generate key performance indicators and mathematical formulations can be stored in a single location as an index table 820 by a component of the system 100 of FIG. 1 and this index table can be accessible by the user through use of the taskbar 810. The user can use the index table 820 (e.g., a sortable index table) to identify issues of the process control system 110 of FIG. 1. The GUI 800 also includes a multi-select index able group creation and preview section 830. In this example, entries are sorted according to MV:StepOutCount. From section 830, system components can be highlighted and a group can be created. With the group being created, a trend plot 840 displaying MV:StepOutCount trends is presented.

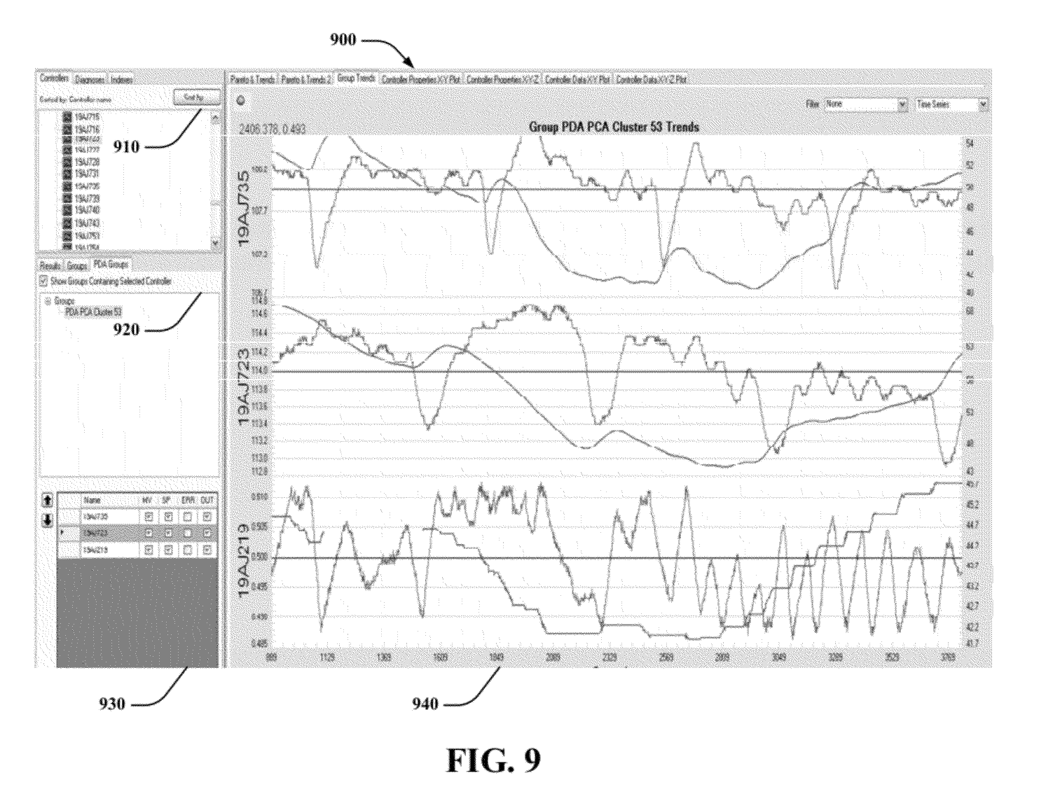

FIG. 9 illustrates an example of a GUI 900 that facilitates entity searching in groups. Groups can be built and visually verified by a user. The user troubleshoots a system (e.g., the process control system 110 of FIG. 1) by locating clusters that contain an entity of interest (e.g., an entity with a failing key performance indicator). The GUI 900 can enable the user to quickly determine if critical components are being acted upon by other entities. The illustrated GUI 900 includes multiple sections. A first section 910 lists controllers that are part of the PCS 110 of FIG. 1. In this first section, the user can sort the controllers and highlight at least one specific controller (e.g., Controller 19AJ723). In section 920, groups can be displayed that include the highlighted controller(s). The user can highlight a displayed group and in section 930 controllers of this group are displayed. A trend plot 940 can be displayed showing performance of the controllers of the group (e.g., the controllers listed in section 930).

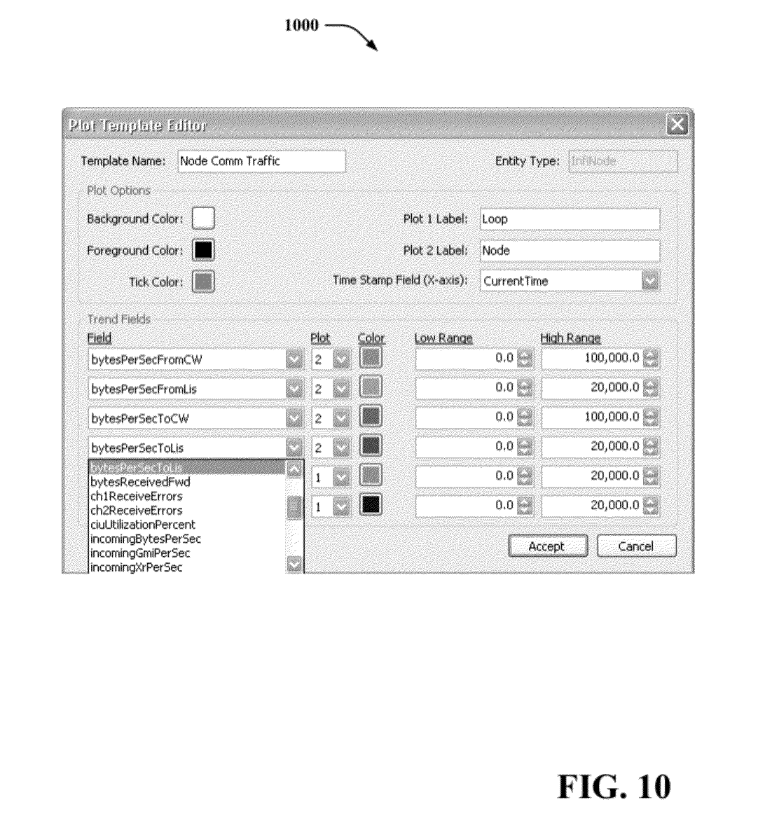

FIG. 10 illustrates an example menu 1000 that enables a user to select which pieces of performance data to view in a trend plot from performance data available for a given entity type. The menu 1000 can provide the user with a high level of customization. A user can use the menu 1000 to create a plot template. A plot template name can be added and plot options selected such as background color, foreground color, tick color, plot labels, and x-axis parameters. Additionally, the menu 1000 enables selection of field, plot, color, and range limits for different trend fields. It is to be appreciated that items shows in the menu 1000 are merely an example and that other items, more items, and less items can be shown.

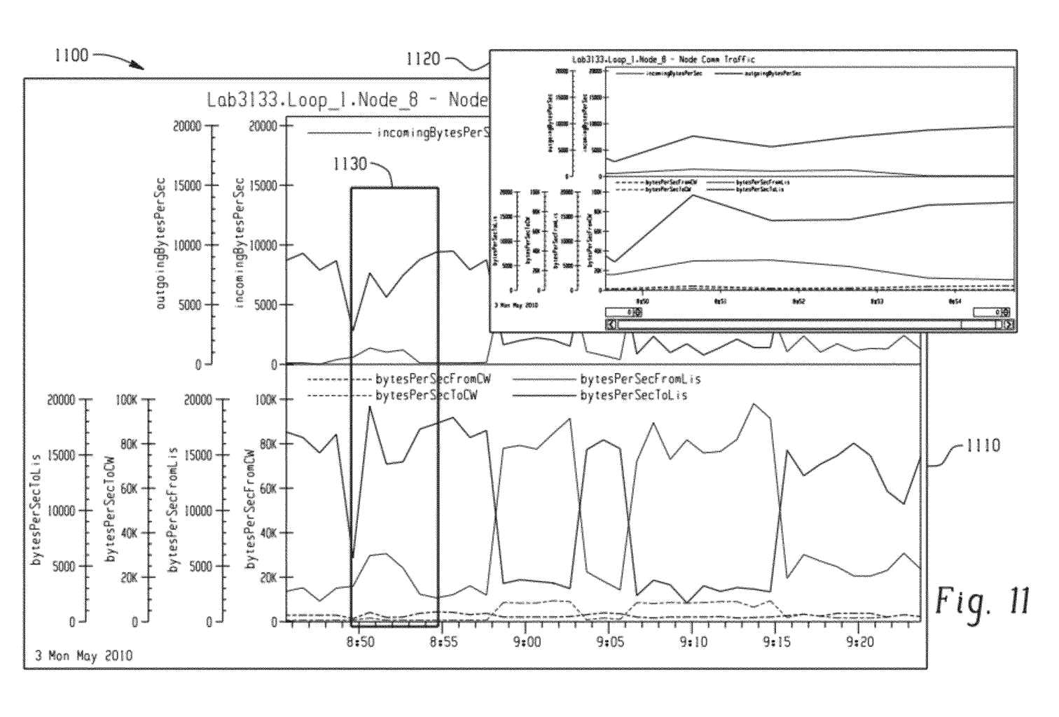

FIG. 11 illustrates an example of a GUI 1100 that uses zooming on a trend plot 1110. The trend plot 1110 can be displayed along with a zoomed plot 1120 based, at least in part, on the trend plot 1110. The trend plot 1110 can be similar to the trend plot 420 of FIG. 4. In one example, a user can engage with the GUI 1100 to cause zooming in on a range of data and scroll a window across an axis (e.g., x-axis). For example, the user can drag a mouse cursor to create a selection box 1130. When the user releases a mouse button, the system 100 of FIG. 1 can cause the zoomed plot 1120 to be presented along with the trend plot 1110.

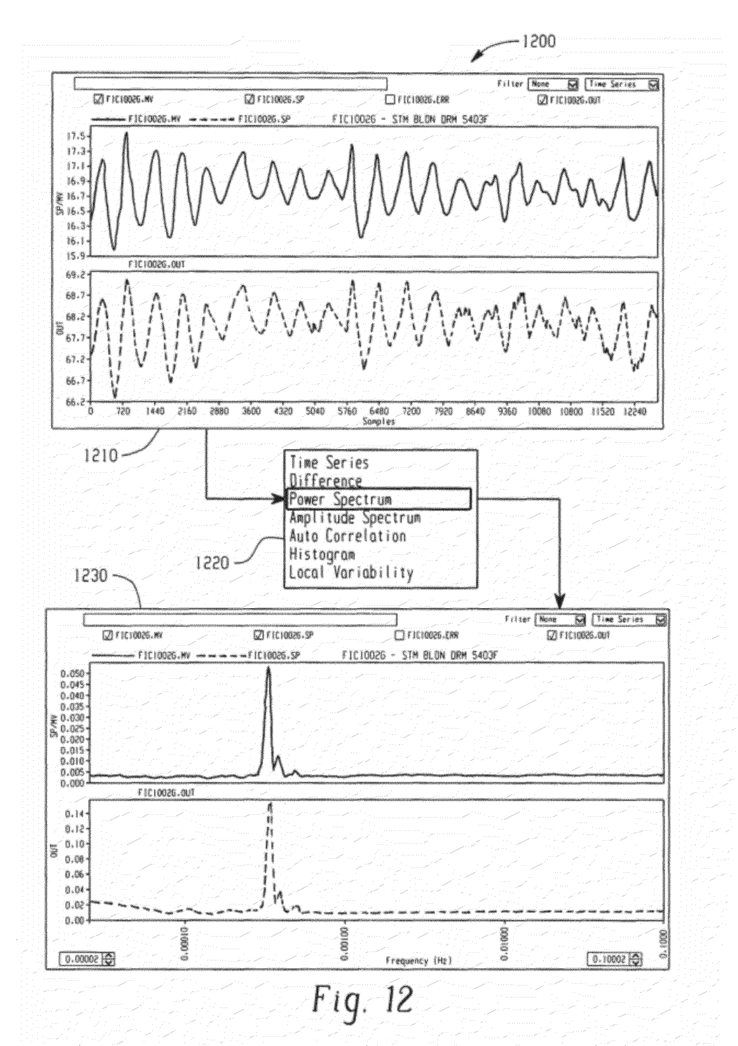

FIG. 12 illustrates an example of a GUI 1200 of analysis trend options. The analysis trend options can be produced from a user performing numerical evaluations on performance data. Example analysis trend options can include spectrums, histograms, auto correlations, cross correlations, different calculations, and local variability. The analysis trend options displayed in the GUI 1200 can change in response to selection of a visualization trend. For example, the GUI 1200 can present a trend plot 1210 related to performance of components of the PCS 110 of FIG. 1. The user can right-click with a mouse on the trend plot 1210 which brings up a analysis trend option list 1220. This list can include different analysis trend options to display. Example options can include time series, difference, power spectrum, amplitude spectrum, auto correlation, histogram, and local variability. The user selects an analysis trend option from the list 1220 and in response to this selection a specific plot 1230 is presented based on the selection.

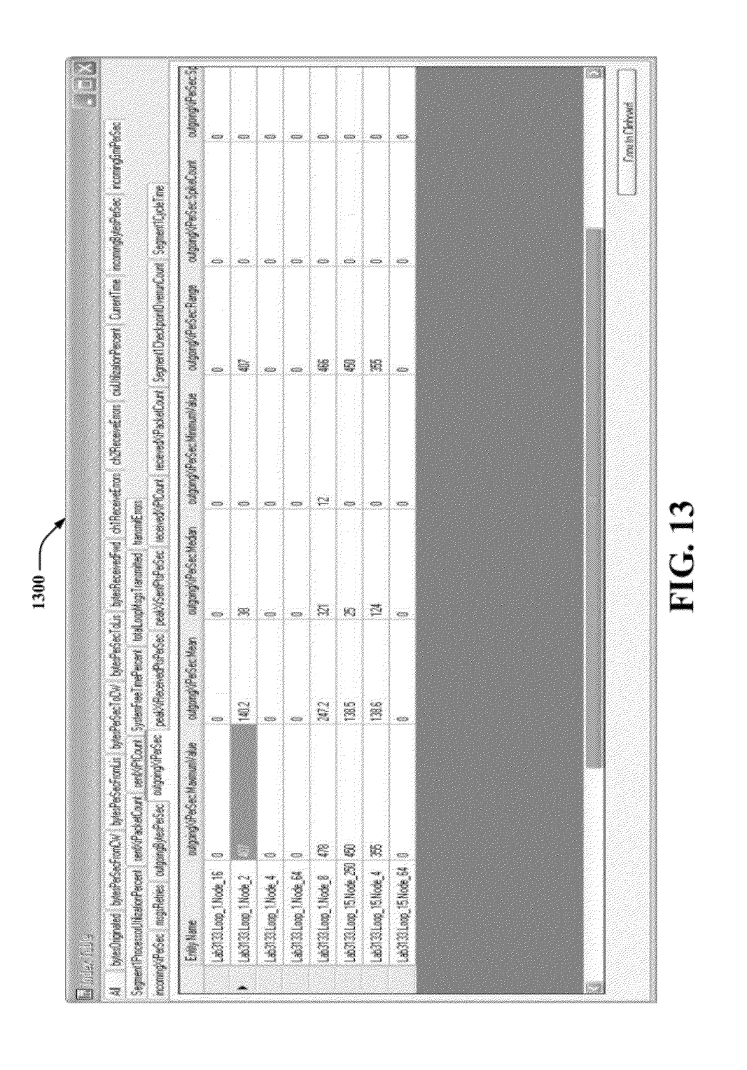

FIG. 13 illustrates an example of a table 1300 that includes statistical table results. A user can use the GUI to apply a numerical method to performance data. Example numerical methods include standard deviation, CoV (coefficient of variation), maximum, minimum, average, range, etc. In one embodiment, results of a numerical method can be stored along with an automatically determined key performance indicator. The table 1300 can include various tabs that can provide various types of information related to system performance.

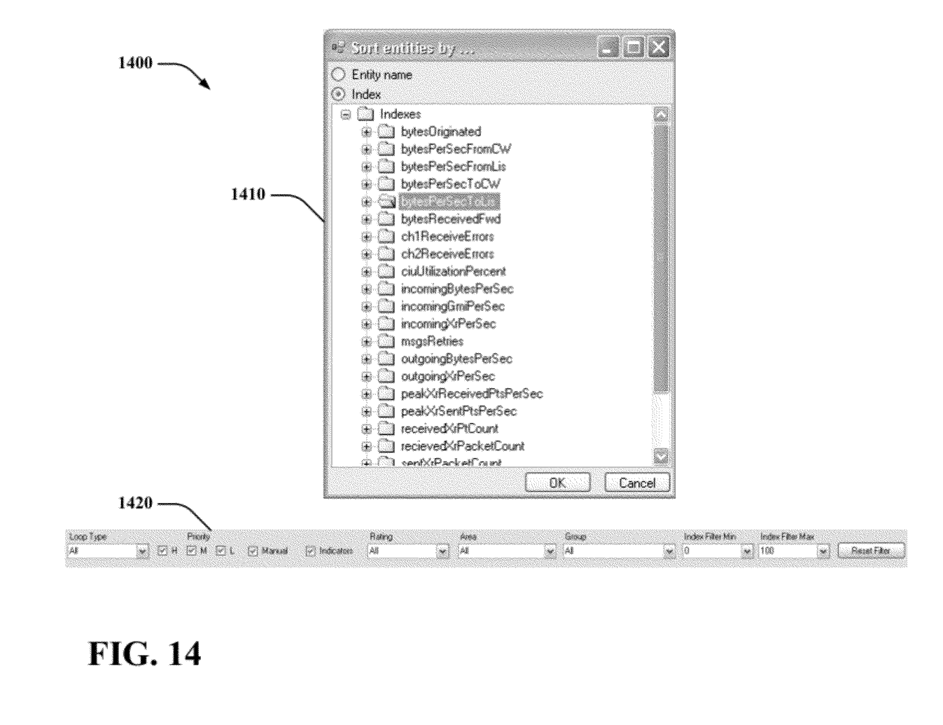

FIG. 14 illustrates an example of a GUI 1400 that facilitates a user ability to sort entities. A first portion 1410 of the GUI 1400 can enable a user to select sorting options while a second portion 1420 of the GUI 1400 shows the sort order. Example sort options can include controller type, process area, criticality, priority, rating, area, group, filter minimum, filter maximum, or user specified sort criteria.

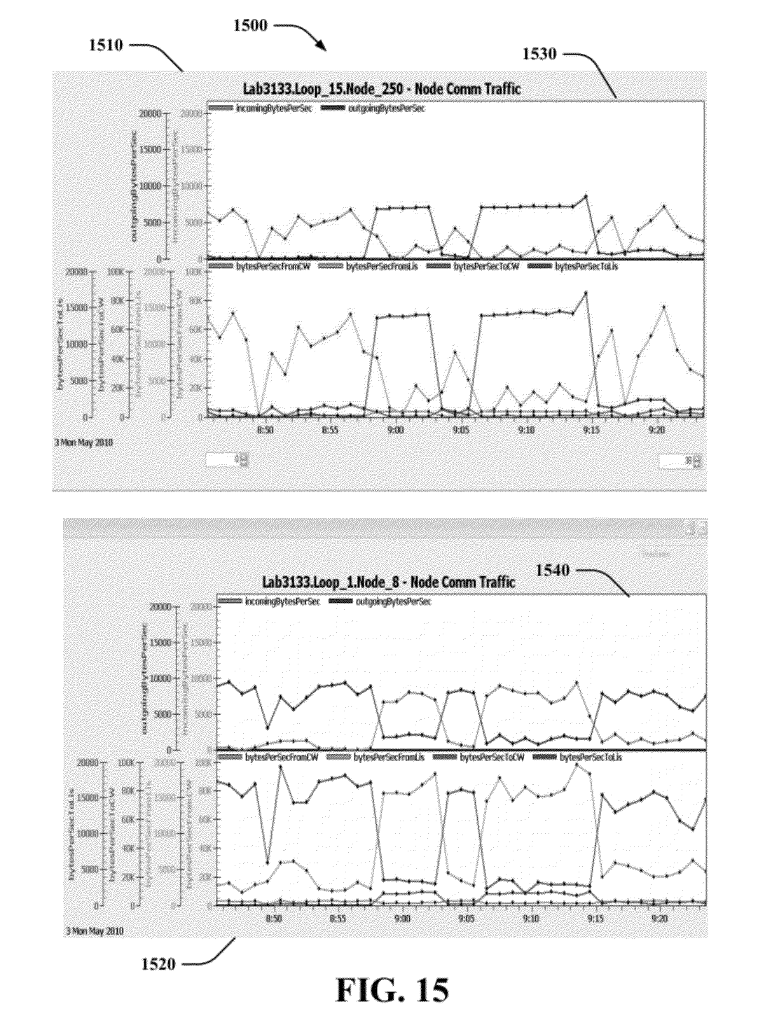

FIG. 15 illustrates an example of a GUI 1500 with first and second windows 1510 and 1520. The first window 1510 shows a trend plot 1530. While the information of the trend plot 1530 may be useful to a user, it may be difficult for a user to understand how a component represented by the trend plot 1530 is operating. Thus, the user may want to compare the trend plot 1530 with another trend plot. For example, the user can desire to compare the trend plot 1530 against a trend plot of a component known to be working properly. As such, the user can cause the second window 1520 to be displayed presenting a second trend plot 1540. These trend plots can be presented simultaneously (as show) so the user can easily compare performance system entities or separately. By way of example, a user can view the window 1510. Based on this viewing, the user can decide to compare the first entity against a second entity. The window 1520 can be generated that discloses a trend plot for the second entity. Thus, a user can make quick comparisons between entities and use the comparison to determine where, how, why, etc. a problem is occurring.

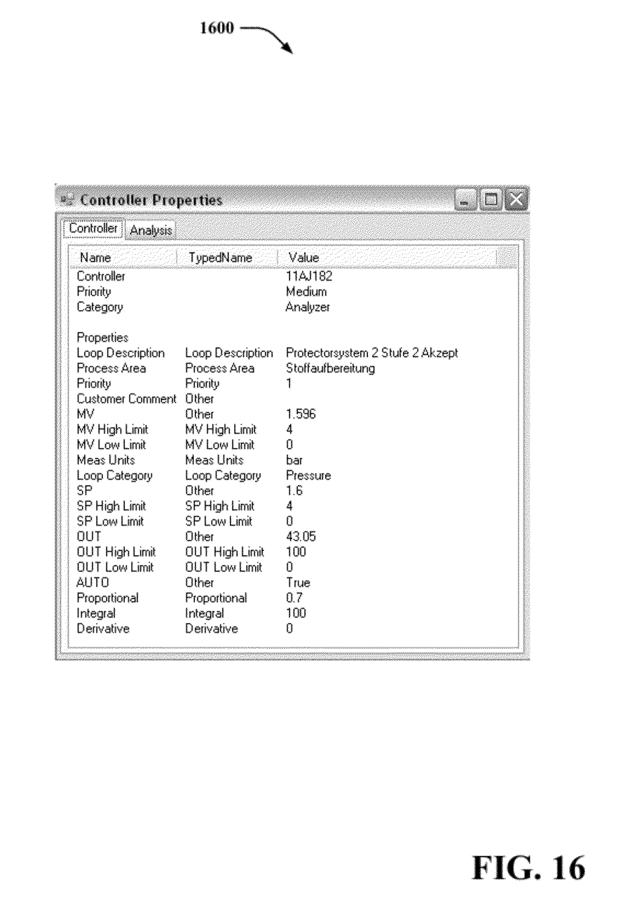

FIG. 16 illustrates an example of a GUI 1600 that presents an entity property view. The GUI 1600 can enable a user to quickly visualize configuration and topology information related to an entity. The GUI 1600 can aid the user in determining if a problem is hardware configuration related or performance related.

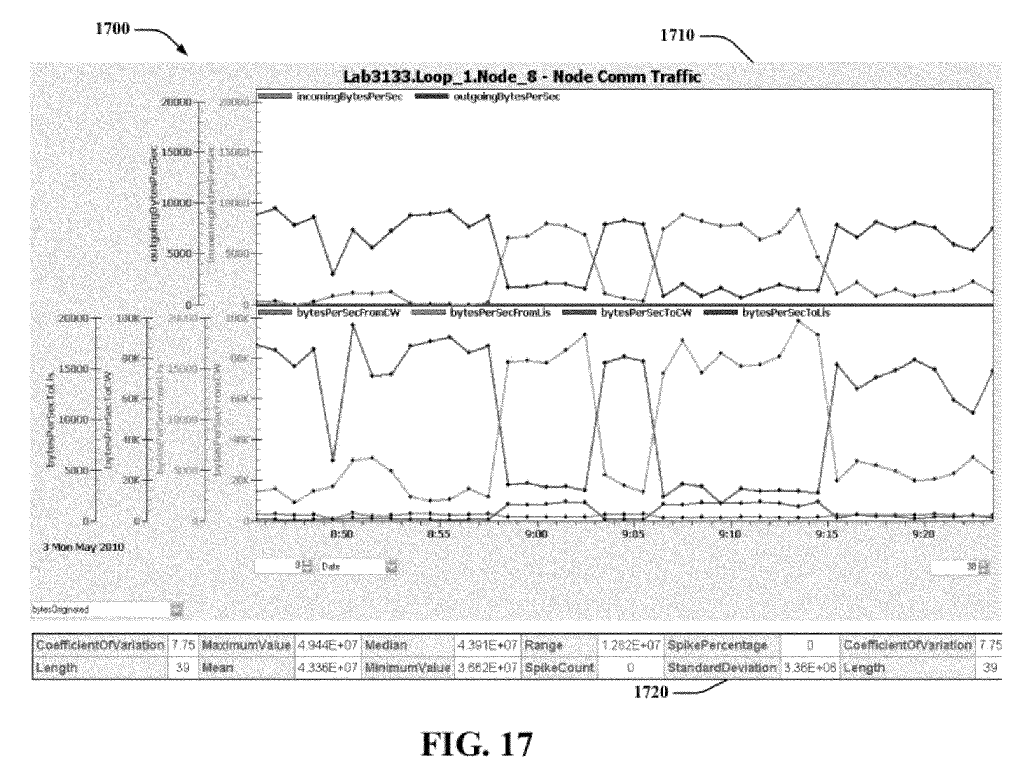

FIG. 17 illustrates an example of a GUI 1700 that presents trend and numerical data views. Matching trend and numerical data views can train a user on how to evaluate data as well as enable the user to quickly evaluate performance of a system (e.g., the process control system 110 of FIG. 1). In short, numerical data and a process trend can be viewed against one another in the GUI 1700. Information (e.g., numerical data) can be automatically updated as information becomes available. The illustrated GUI 1700 includes a trend plot 1710 similar to what is disclosed in FIG. 4. In addition to the trend plot, an information bar 1720 is presented. This information bar 1720 can provide various mathematical information pertaining to the trend plot 1710. For example, the information bar can show length information, mean, median, range, spike count, and others. The user can view this mathematical information and use it to assess system performance.

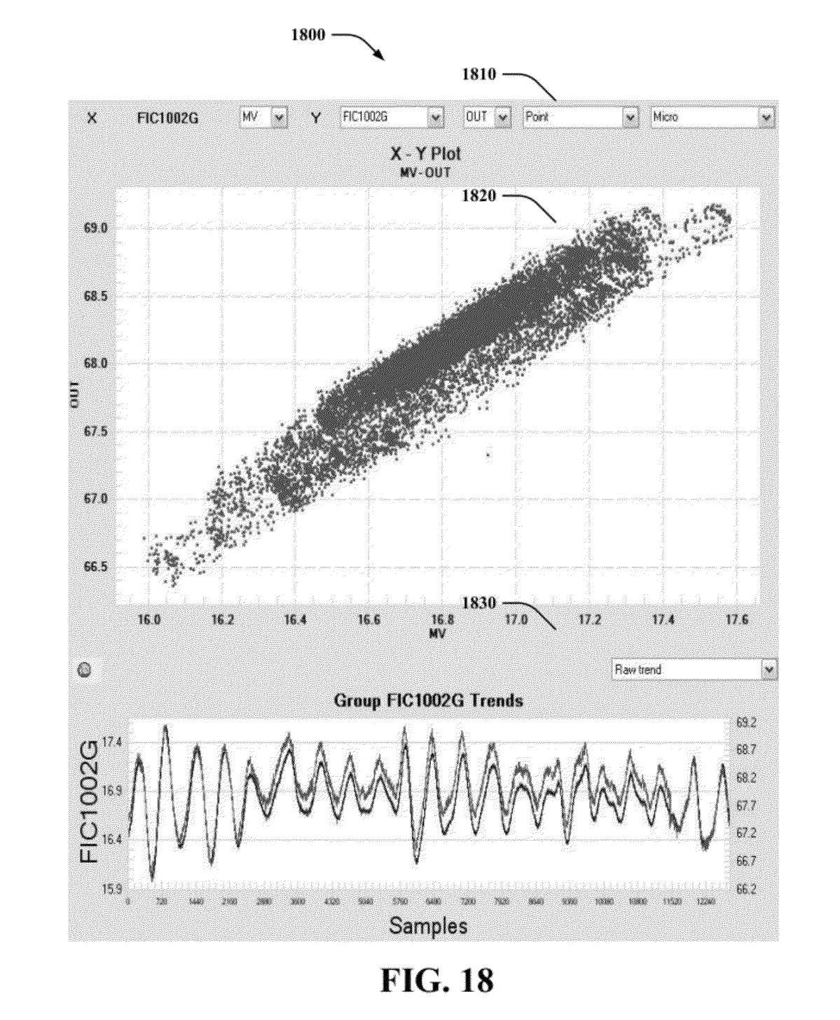

FIG. 18 illustrates an example of a GUI 1800 that includes an XY trend plot. Previously discussed visualization (e.g., GUI 1700 of FIG. 17) can include an x-axis that is based on time or frequency. However, other configurations can be practiced. For example, the illustrated GUI 1800 discloses variables plotted against each other. For example, samples of performance for an entity can be taken at different times and results at these times can be represented on a plot 1820. Additionally, the GUI 1800 includes a field bar 1810 that enables a user to configure the GUI 1800. For example, the user can use the field bar 1810 to select point mapping as opposed to a line graph. Along with the X-Y plot 1820, the GUI 1800 shows a trend plot 1830.

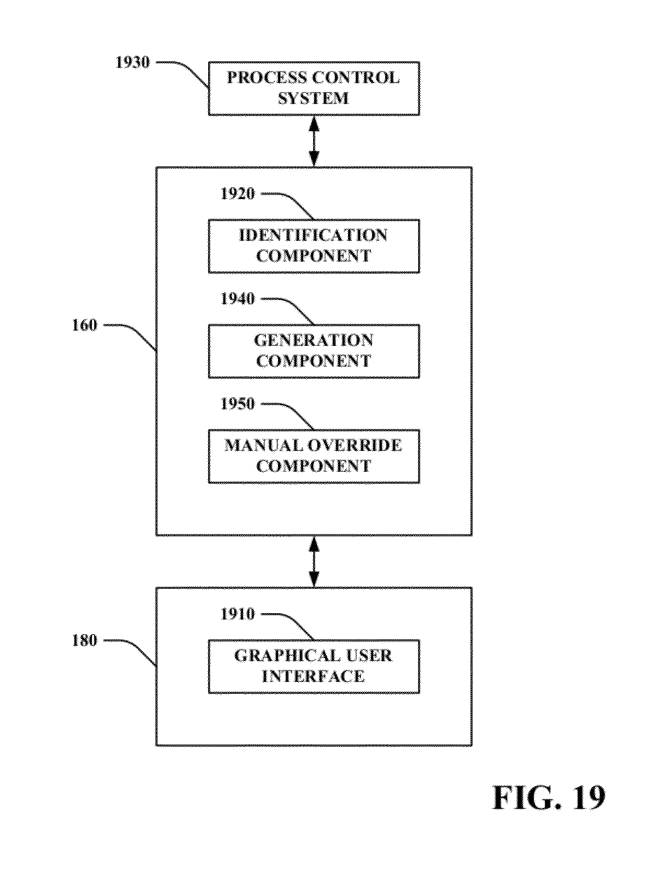

FIG. 19 illustrates an example of the visualization component 160 that produces a GUI 1910, which indicates key performance indicator information. The visualization component can include an identification component 1920 configured to identify a set of key performance indicators that do not meet predetermined criteria. The identification component 1920 identifies a priority level order for individual key performance indicators. However, the identification component 1920 can function outside the visualization component 160 (e.g., as a separate component). The set of key performance indicators is indicative of performance of a process control system 1930 (e.g., provide a numerical value that is proportional to an attribute that is associated with performance of a controller of the process control system 1930).

In one embodiment, the evaluation component 140 of FIG. 1 evaluates a data set of the process control system 1930. The interpretation component 150 of FIG. 1 determines if individual key performance indicators of the group of key performance indicators meet the desired result based, at least in part, on the evaluation. The identification component 1920 identifies the set of key performance indicators based, at least in part, on the determination of the interpretation component 150 of FIG. 1. For example, a first key performance indicator could have a value that does not satisfy (or is outside of) a predetermined acceptable value for the first key performance. As such, the first key performance indicator is identified and added (e.g., by the identification component 1920) to the set of key performance indicators. A third key performance indicator can have a value that satisfies a corresponding predetermined acceptable value. In this instance, the third key performance is not added to the set of key performance indicators.

A generation component 1940 presents information indicative of the set of key performance indicators that do not meet the predetermined criteria and the data used to identify this set of key performance indicators in a GUI 1910. While the GUI 1910 includes the set of key performance indicators that do not meet the desired result, the GUI 1910 may also includes at least part of a set of key performance indicators that do meet the desired result. For example, the GUI 1910 can show the first, second, and third key performance indicators and associated data.

In one embodiment, the interpretation component 150 of FIG. 1 can determine how successful or unsuccessful for an individual key performance indicator is from a predetermined criteria (e.g., a level of success). Based, at least in part, on this level of success, the generation component 1940 can determine a presentation order for the key performance indicators in the GUI 1910 (e.g., key performance indicators that are furthest from their predetermined criteria are presented first in a list). In another example, the interpretation component 150 of FIG. 1 can determine an importance level of an entity related to the key performance indicators. Based, at least in part, on these importance levels, the generation component 1940 can cause the information of key performance indicators that are more important to be displayed on the GUI 1910 ahead of information of key performance indicators that are less important.

As such, the generation component 1940 can automatically produce a GUI 1910 on the monitor 180 that discloses key performance indicator information (e.g., a marker of the key performance indicator, data related to performance of the key performance indicator, etc.). This automatic production can be performed by using a predetermined rule set (e.g., computer logic followed to construct the GUI 1910). However, a user can evaluate the GUI 1910 and make a subjective evaluation of the key performance indicators. Based on this evaluation, the user can decide to change the key performance indicators (e.g., change the status of a key performance indicator). A manual override component 1950 enables a manual modification of the GUI 1910 upon the monitor 180. While the identification component 1920, generation component 1940, and manual override component 1950 are depicted as part of the visualization component 160, it is possible for other configurations to occur (e.g., the identification component 1920 to not be part of the visualization component 160).

In one example, the manual modification includes manual addition of a non-included key performance indicator to the set of key performance indicators when the non-included key performance indicator satisfies the predetermined acceptance criteria. For example, the GUI 1910 initially shows key performance indicator A as not meeting a predetermined criteria. As such, the visualization component 160 causes the output to display key performance indicator A as failing (e.g., highlighted in red). However, a technician can determine that key performance indicator A is functioning well enough and switch key performance indicator A from failing to passing (e.g., the switch can be performed by the manual override component 1950 in response to an instruction entered by the user upon the graphical user interface 180).

In one example, the manual modification comprises manual deletion of an included key performance indicator from the set of key performance indicators when the included key performance indicator does not satisfy the predetermined acceptance criteria. For example, the GUI 1910 initially shows key performance indicator B as meeting a desired result. As such, the visualization component 160 causes the GUI 1910 to display key performance indicator B as not failing (e.g., highlighted in green). However, a technician can determine that key performance indicator B is functioning too close to failing range and switch key performance indicator B from not failing to failing.

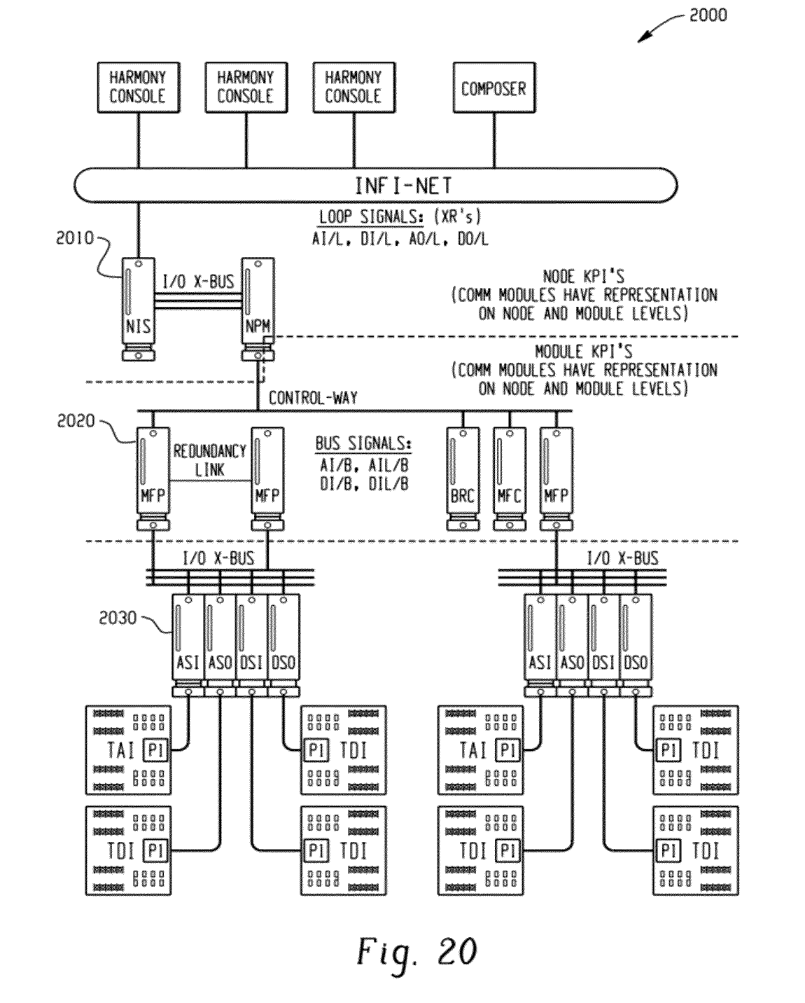

FIG. 20 illustrates an example of an example process control system 2000. In one embodiment, the system 100 of FIG. 1 defines and retains a list of common failures. The system 100 of FIG. 1 can matches the common failures with commonly available key performance indicators. From this, diagnosis can be made for parts of the process control system 2000. The process control system 2000 can be broken down into nodes 2010, modules 2020, or I/Os 2030. A loop in the process control system 2000 can include multiple nodes 2010 that contain various intelligent and I/O modules 2020. Node level diagnosis can include performance diagnosis or configuration diagnosis. Performance data used to make the performance diagnosis can include primary communications, XR traffic, NIS events, and error counters.

Configuration data used to perform a configuration diagnosis can include active NIS firmware, memory, utilization of the module, and switch positions. A module 2020 that is part of a loop can perform different functions in the process control system 2000. The module 2020 can be intelligent and be directly addressed for diagnosis purposes. For example, a module 2020 can provide a module status report on demand or via an XR tag and this report can be specific to the module 2020. The module status report gives a summary overview of the state and heath of the module and can include function block information, loading, backup checkpointing, and memory utilization. The retrieve component 120 of FIG. 1 can collect the module status report and the system 100 of FIG. 1 can use the module status report in producing the GUI 170 of FIG. 1.

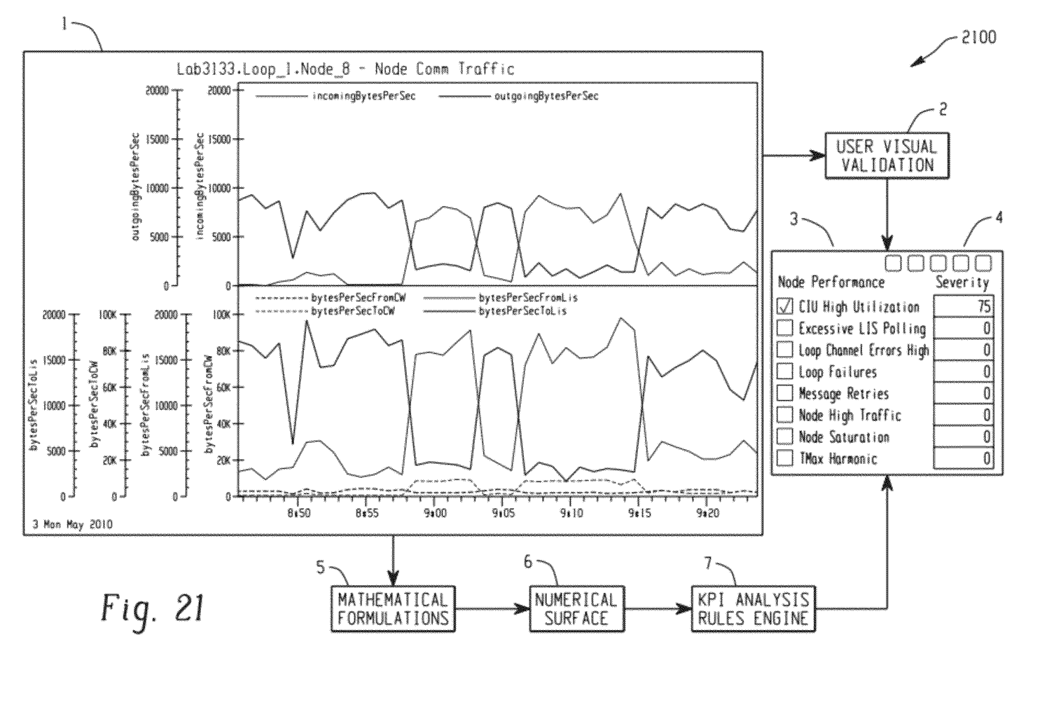

FIG. 21 illustrates an example of a system 2100 with a series of blocks 1-7. When performing manual modification, a user can look at a visual presentation of the data (block 1 (a visualization)) and then manually set a KPI that can be visibly detected. This path would be defined as going from blocks 1 to 2 to 3 and then 4 (e.g., where blocks 2, 3, and 4 are facilitated by the manual override component 1950 of FIG. 19). KPI severity is often difficult to define in a manual setting. This is often left to a zero or a one to match the true or false indication of the KPI. An automatic method of detection starts with the raw data and applies the mathematical formulations. The results are then placed into a numerical table or numerical surface.

The numerical surface is then acted on by a KPI analysis rules engine (e.g., that can be part of the system 100 of FIG. 1) and the numerical values that acted as triggers in the analysis rules engine are color coded (e.g., by the generation component 1940 of FIG. 19). The analysis engine looks for patterns in the numerical surface that correlate well with the designated KPI's. Since the numerical surface is now color coded to match the analysis rules, users can start matching the colors of the numerical surface with identifiable wave patterns in the raw data (e.g., through use of the manual override component 1950 of FIG. 19). The flow would be 1-5-6-7-3-4. The severity is often defined as a magnitude of one of the mathematical formulations and is scaled from 0 to 100 percent when possible.

By using the system 100 of FIG. 1 (e.g., where the system 100 of FIG. 1 incorporates aspects of the system 2100), the user defines an analysis window that represents a normal period of operation (e.g., by engaging the user interface 180 of FIG. 1). The user then activates automatic identification of KPI's (e.g., instruct the identification component 1920 and generation component 1940, both of FIG. 19, to begin operation). Once the KPI table is formulated, the user can then quickly step through the controllers, view the numerical surface and the associated KPI's. If the user sees discrepancies or even problems that were note detected, the user can simply over rides the KPI results.

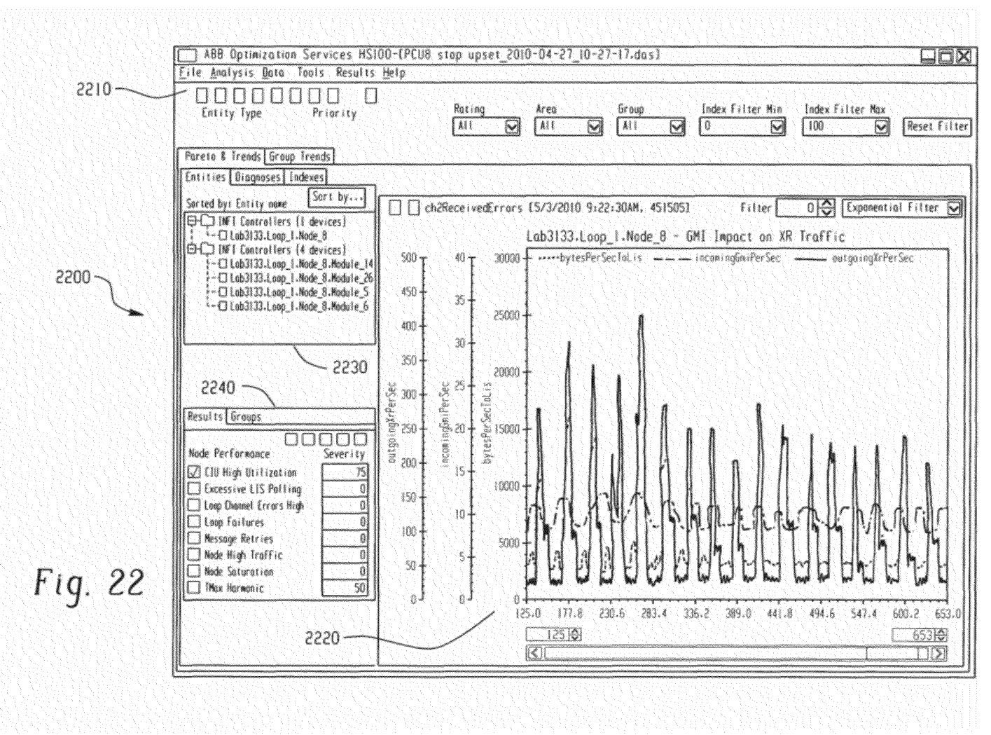

FIG. 22 illustrates an example of a GUI 2200. The GUI 2200 enables the user to visually see in a trend that there is a spike pattern in the XR traffic, but the severity of other issues depends on other factors such as total loading of the node and the magnitude of the spikes. Aspects disclosed herein go beyond the identification of a limit or pattern in performance characteristics and rate the severity of the issue in context with other data. The user can then go back and examine the raw data, the numerical surface, and now see the KPI analysis results and their color triggers. The user can then accept or reject this finding. In this graphical user interface, a problem is shown with the Tmax configuration of the controllers in the node leading to this traffic pattern, but the spikes do not reach the limits of an NPM01 to transmit the messages to the loop.

With this presentation of the GUI 2200, the human eye can pick up on patterns very quickly. Aspects disclosed herein allow the user to use basic process control troubleshooting skills when viewing a display. The user can select a controller and the system 100 of FIG. 1 causes a display with automatic updates to show the user what was identified. If the automatic identification does not match the user's view of the data, the user can override the diagnosis by way of the GUI 2200 and through use of the manual override component 1950 of FIG. 19. As a result, a user can typically step through many of data sources in a relatively short amount of time. In addition to the speed of an accurate analysis, the user and the system (e.g., artificial intelligence used by the generation component 1940 of FIG. 19) can learn based on operation. If the user has to override many of the same types of findings, the user can then adjust thresholds and even analysis rules to get the auto identification to match their visual identification. To put another way, the user can adjust logic used by the generation component 1940 of FIG. 1 that is used to produce outputs.

The GUI 2200 includes various portions that can enable a user in analyzing health of the PCS 110 of FIG. 1. A command bar 2210 enables the user to perform various functions related to a plot 2220. For example, a user can engage a save icon of the command bar 2210 in order to save a group, save the plot 2220, and others. In addition, the GUI 2200 can include an entity list section 2230 and a selection section 2240 where performance characteristics are chosen for inclusion on the plot 2220.

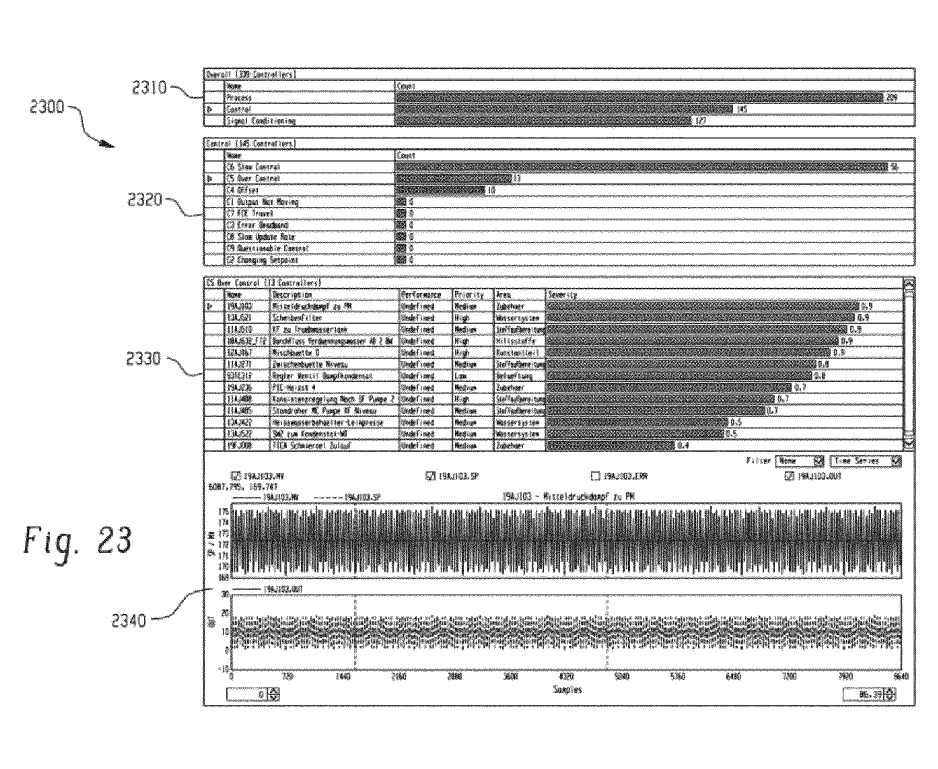

FIG. 23 illustrates an example of a GUI 2300 that presents key performance indicator information. The GUI 2300 can be an output produced by the generation component 1940 of FIG. 19. Once the output is presented, a user can select a controller set and manually step through individual controllers. Conversely, the user can quickly look at logical groupings of the KPI results together. The KPI results can be based on a hierarchical structure. At a first level 2310, a number of DCS entities is calculated and overall ratings for KPI categories is shown. A second level 2320 shows the number of problems with a particular KPI for an entity. A third level 2330 shows the entities that were identified as having a problem. They are then sorted by the severity of the KPI at a fourth level 2340. This allows for the data to be sorted such that the entities with the highest probability of having a problem are drawn to the surface.

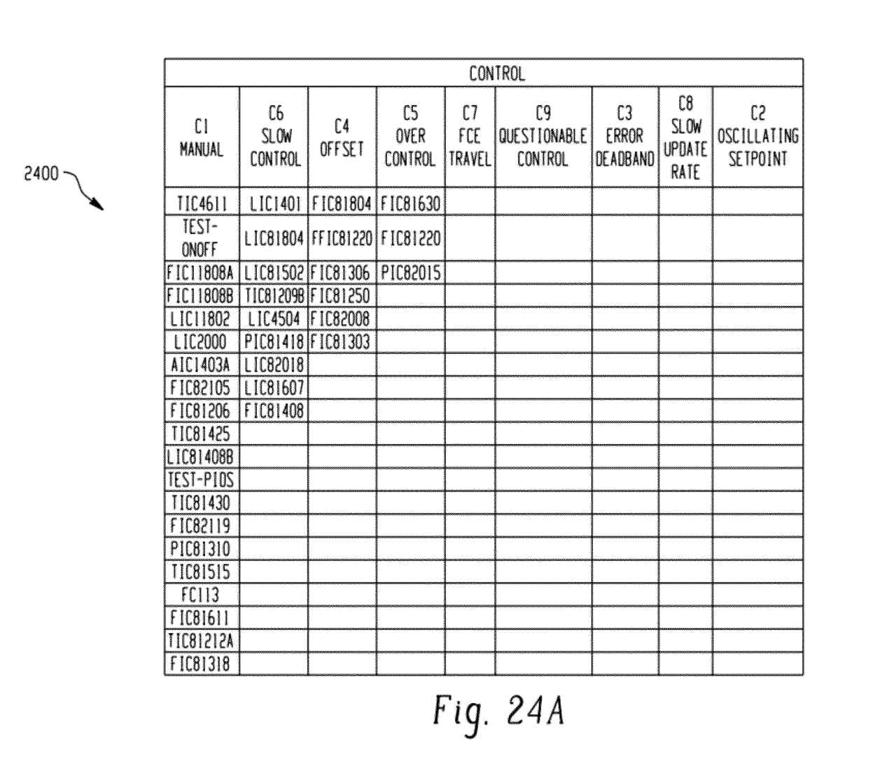

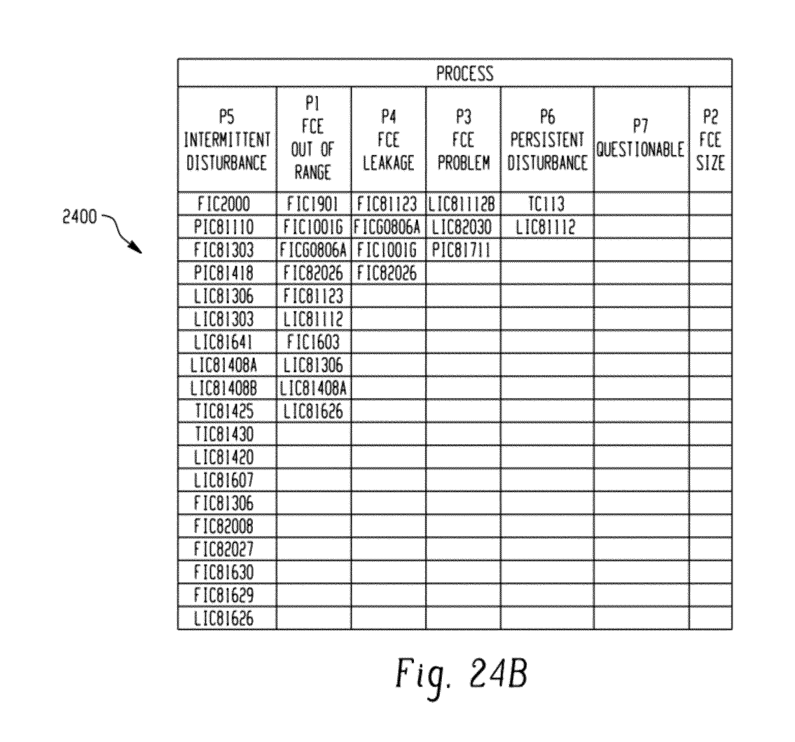

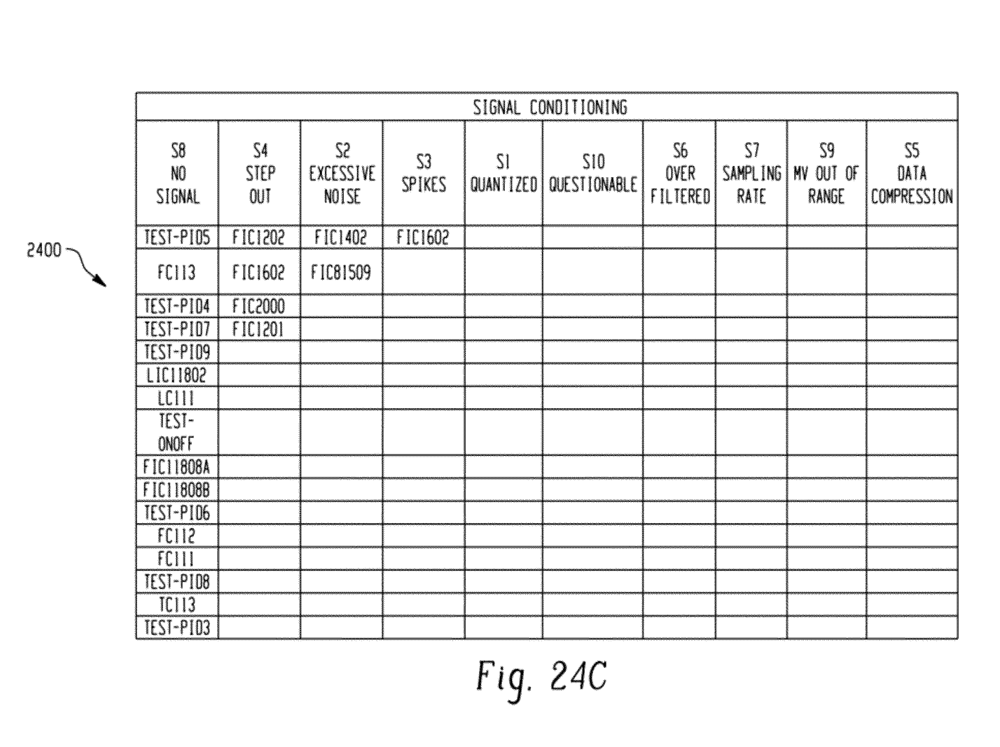

FIGS. 24A, 24B, and 24C illustrate different versions of an example GUI 2400 that reports performance. The example GUI 2400 in FIG. 24A shows a table reporting control performance, the example GUI 2400 in FIG. 24B shows a table reporting process performance, and the example GUI 2400 in FIG. 24C shows a table reporting signal conditioning performance. In one embodiment, the tables of FIGS. 24A, 24B, and 24C can be shown together (e.g., one GUI 2400 that includes the table reporting control performance, the table reporting process performance, and the table reporting signal conditioning performance).

In addition to the KPI navigation, an output (e.g., output report that includes the GUI 2400) can be generated that includes an action list that is matched to the severity of the KPI. This output report allows for users to target solutions to top offenders (e.g., KPIs that most often do not meet a desired result). A table of the output report can be sorted by a user via criticality, process, or user defined criteria to offer the user options on defining how a solution plan can be made. In one embodiment, cells are color coded to match the criticality (e.g., red cells represent components drastically failing to satisfy predetermined criteria).

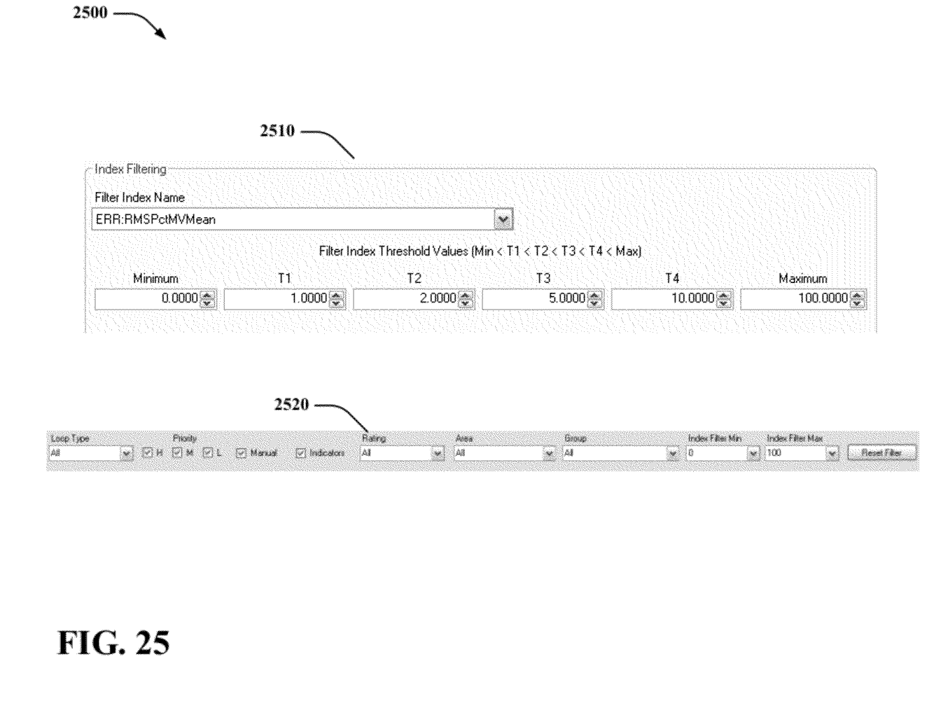

FIG. 25 illustrates an example of a GUI 2500 with a sorting portion 2510 and a definition portion 2520. The sorting portion 2510 can enable index filtering while the definition portion 2520 enables a user to define how items are sorted. KPIs can be filtered by use of the GUI 2500. An example sorting basis can include loop type (e.g., flow, pressure, level, consistency, etc.), priority (e.g., high, medium, low, etc.), exclude loops that are in manual or are indicators, overall performance rating, process areas, controller groupings, or user specified statistical results. Based on this sorting, a user can define definitions of criticality of KPIs.

In addition to the user defined definitions of criticality, users may define high critical components, medium critical components and low critical components. The user can sort problems based on customer defined criticality values. Numerical methods used by an analysis engine can be used to sort the DCS entities. The user selects a filter index name from a drop down window and sets break points for that index. The user then can specify what range of index values to include in a search.

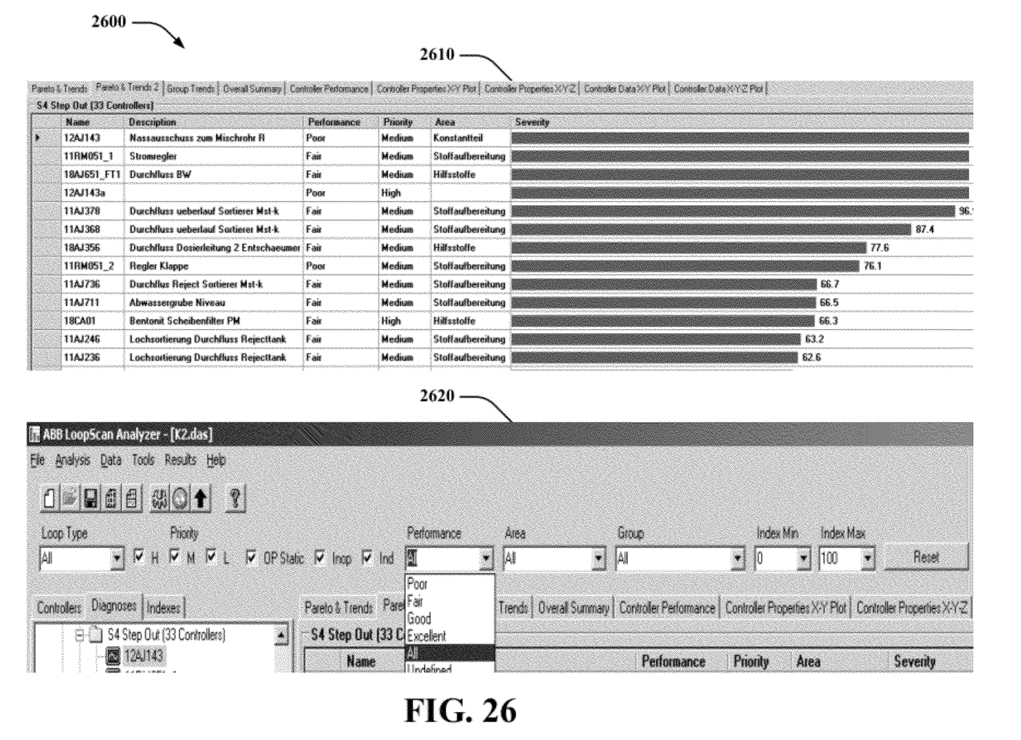

FIG. 26 illustrates an example of a GUI 2600 with a pareto and trend portion 2610 and a filter portion 2620. The system 100 of FIG. 1 calculates the overall performance of individual system (e.g., process control system 110 of FIG. 1) components (e.g., entities). The system 100 of FIG. 1 uses threshold values for a diagnosis to determine an entity performance rating. A diagnosis is assigned threshold values for excellent, good and fair performance. For an entity to be rated as excellent, the diagnoses severities are less than their excellent thresholds. This also applies for good and fair ratings. If an entity does not meet the excellent, good or fair criteria then its performance is rated as poor.

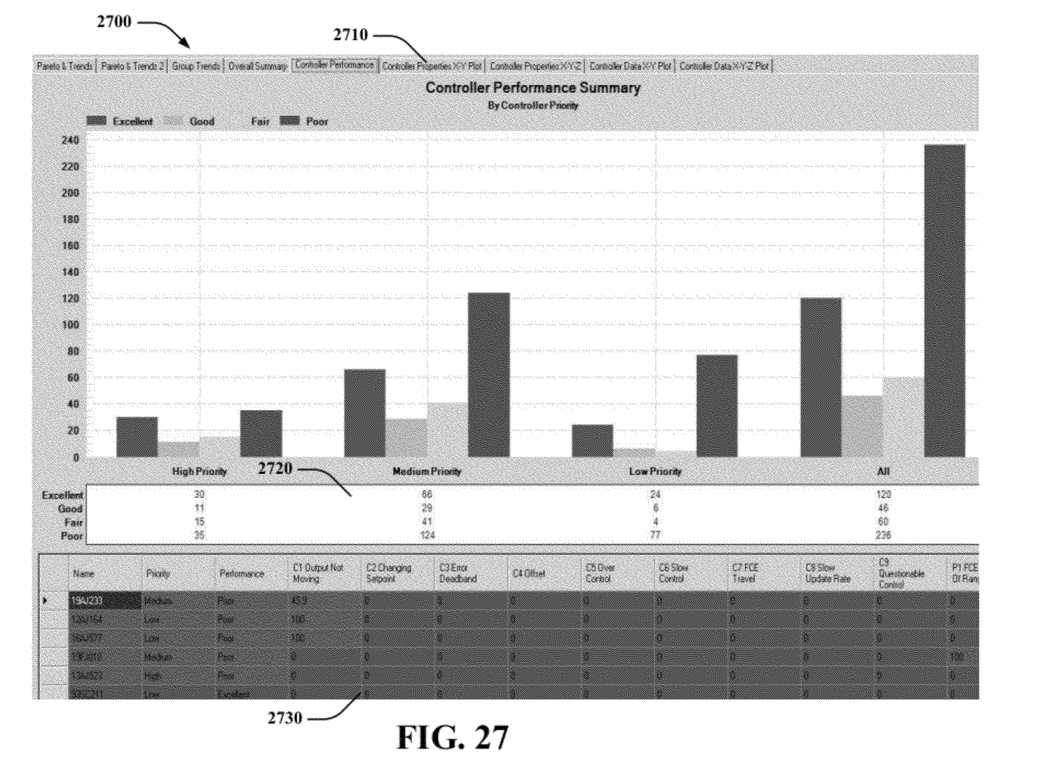

FIG. 27 illustrates an example of a GUI 2700 that presents a performance summary by priority. Based on the outcome of the excellent, good, fair, or poor rating, the visualization 2700 can present to a user how components are performing. For example, high priority components can be grouped together so the user can determine which high priority components are functioning poorly. The GUI 2700 includes three sections to provide different information to the user. The first section 2710 provides a bar graph showing how many components are functioning at different levels as well as the priority level of these components. The second section 2720 can reflect information of the first section 2710, but as opposed to being a bar graph, the second section 2720 shows numerical information. The third section 2730 provides more detailed information on how individual entities are performing.

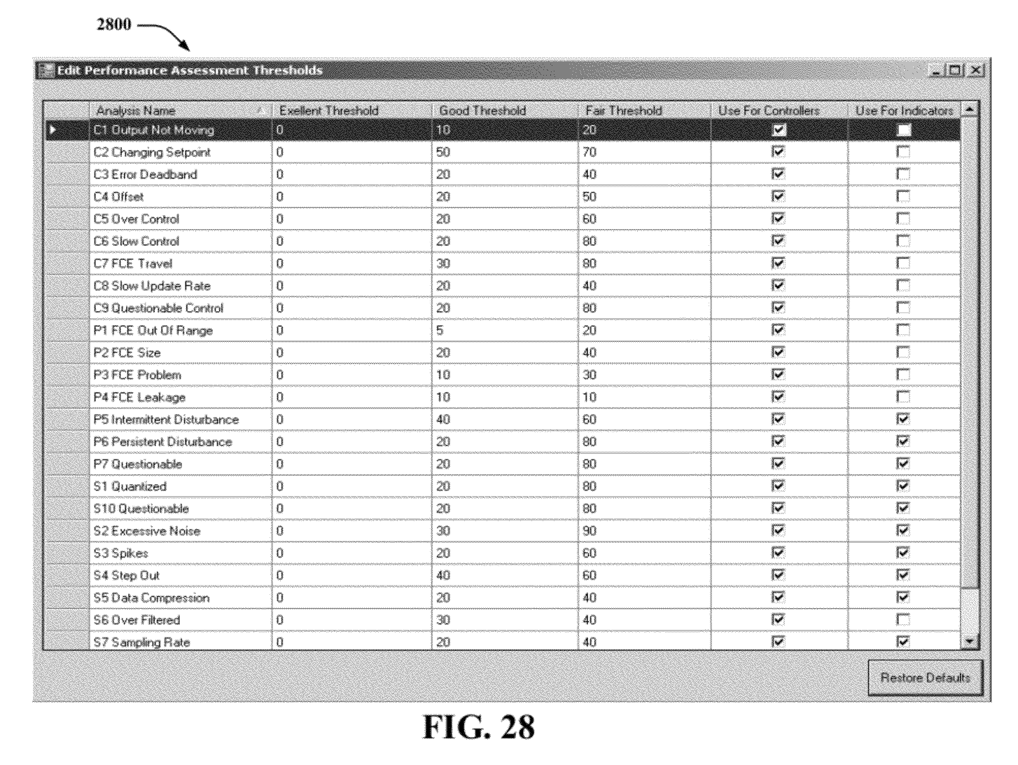

FIG. 28 illustrates an example of a table 2800 with default threshold values. The table 2800 contains example default threshold values for diagnoses and ratings. The user may modify these thresholds. As described earlier, an entity can be rated as excellent, good, fair, or poor. In one embodiment, the severities of all diagnoses must be less than the associated threshold (e.g., if all but one threshold is excellent and the one other is good, then the diagnosis is rated as good), however, other configurations are possible. An entity is first checked to see if it meets the excellent criteria then good then fair. If the entity does not pass these checks then the entity is rated as poor. The “Use for Entities” and “Use for Indicators” checkboxes can determine if the associated thresholds are used in rating controllers and indicators, respectively.

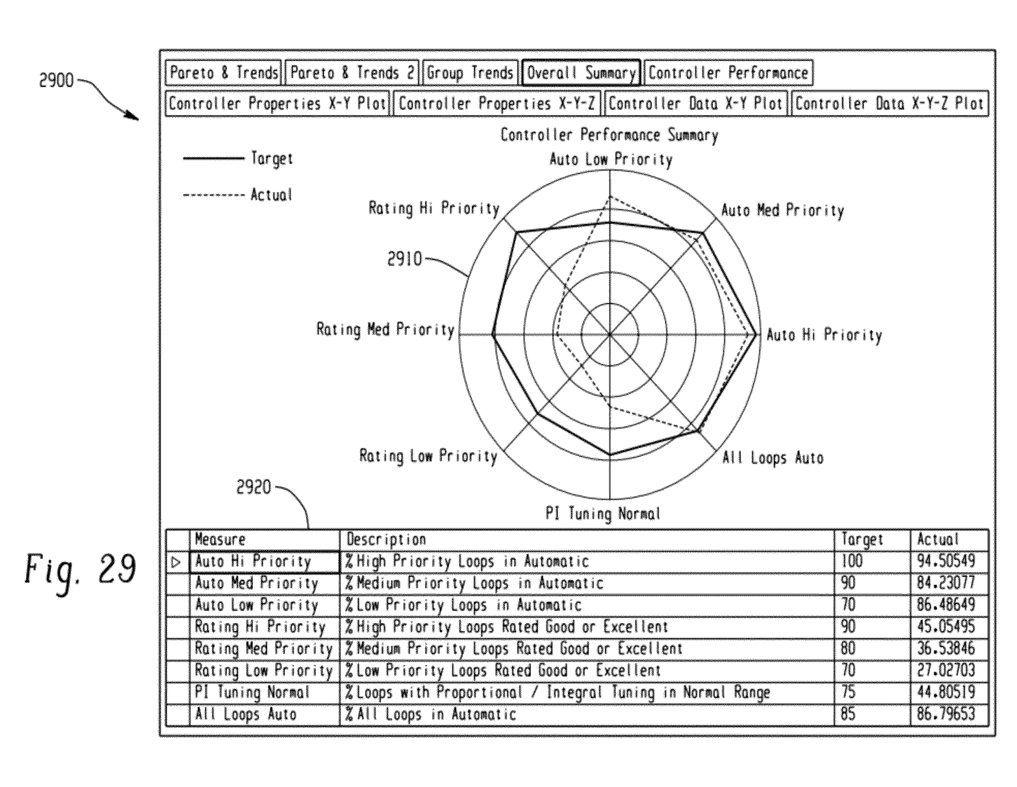

FIG. 29 illustrates an example of a GUI 2900 that presents spider chart summary statistics (e.g., a spider chart 2910 and associated summary statistics 2920). The visualization 2900 can show how entities are performing in an area (e.g., green line) and a desired level of performance, such as excellent performance (e.g., blue line). A user can modify what entities are included regarding the spider chart. Additionally, below the spider chart 2910, the statistics 2920 can take a chart form and provide numerical data represented in the spider chart 2910.

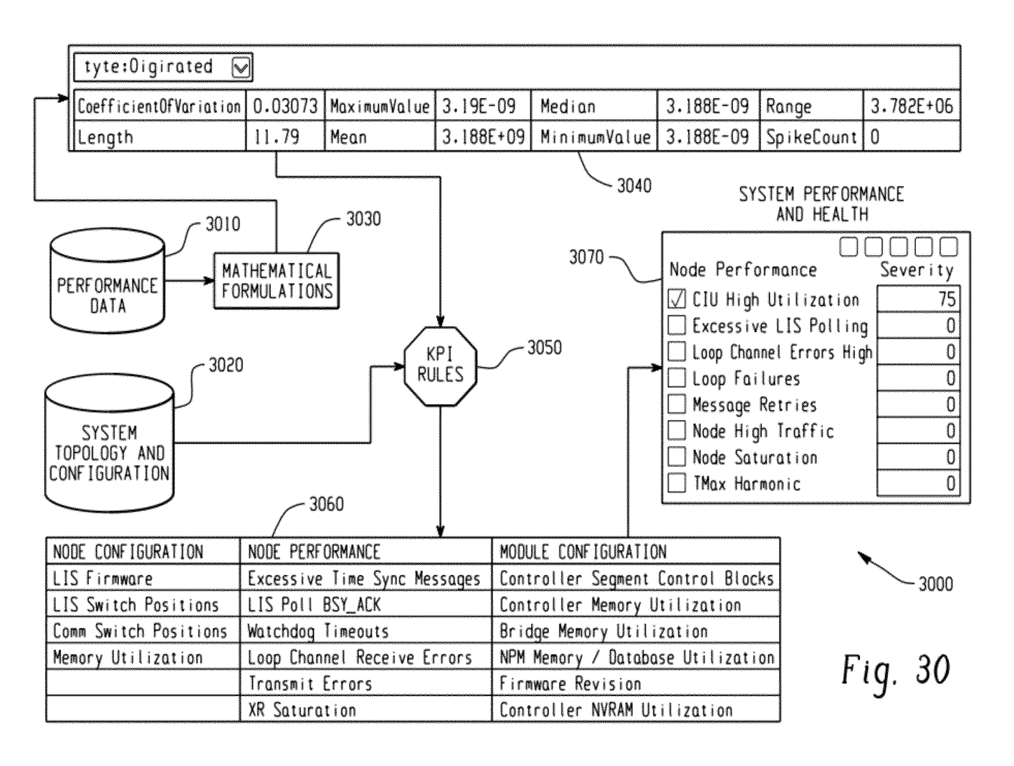

FIG. 30 illustrates an example of a system 3000 for automatic performance signal flow. Performance data is used to calculate various indices on the data, then the data and the indices are fed into a KPI rules engine (e.g., that uses KPI rules and is part of the system 100 of FIG. 1). The KPI rules engine uses the topology and configuration of a system (e.g., process control system 110 of FIG. 1) to provide context for the data to select limits and the appropriate rules to execute. The resulting diagnoses are used to create a system health report. Two databases can retain system information: a performance data database 3010 and a configuration database 3020. Performance data from the database 3010 can be processed by mathematical formulations 3030 and results can be presented in a bar 3040. These results, along with information from the configuration database 3020, can be processed by KPI rules 3050 (e.g., a KPI rules engine). The KPI rules 3050 can output a results table 3060 and from the table 3060 a system performance and health GUI 3070 can be outputted.

The above may be implemented by way of computer readable instructions, which when executed by a computer processor(s), cause the processor(s) to carry out the described techniques. In such a case, the instructions are stored in a computer readable storage medium associated with or otherwise accessible to the relevant computer.

As used herein, the term ‘component’ can refer to software, hardware, firmware, software in execution, or a combination thereof. In one example, a processor can function as one or more components. In another example, one or more of the components can be implemented through a processor executing one or more instructions encoded on computer-readable storage medium such as physical memory or the like. The processor can additionally or alternatively execute instructions carried by a signal or carrier wave.

Of course, modifications and alterations will occur to others upon reading and understanding the preceding description. It is intended that the invention be construed as including all such modifications and alterations insofar as they come within the scope of the appended claims or the equivalents thereof.

What is claimed is:

1. A system, comprising:
an identification component configured to identify a set of key performance indicators that fail to satisfy predetermined acceptance criteria based on acquired performance data, where the set of key performance indicators is indicative of performance of components of a process control system;
a visualization component configured to visually present the identified set of key performance indicators, the components, and the acquired performance data in a graphical user interface displayed via a monitor; and
a manual override component configured to allow a user to manually override and modify the information presented by the graphical user interface based, at least in part, on the acquired performance data.

2. The system of claim 1, where the manual modification comprises a manual change of a state of an included key performance indicator from failing to satisfy the predetermined acceptance criteria to satisfying the predetermined acceptance criteria.

3. The system of claim 1 where the manual modification comprises manual addition of a non-included key performance indicator for a component to the set of key performance indicators when the non-included key performance indicator satisfies the predetermined acceptance criteria.

4. The system of claim 1, comprising:
an evaluation component configured to evaluate a data set of the process control system; and
an interpretation component configured to determine if individual key performance indicators of the group of key performance indicators satisfy the predetermined acceptance criteria based, at least in part, on the evaluation,
wherein the identification component identifies the set of key performance indicators based, at least in part, on the determination.

5. The system of claim 1, where the information indicative of the identified set of key performance indicators is visually presented in order of severity.

6. The system of claim 1, where the predetermined acceptance criteria is specific to an individual key performance indicator and where the set of key performance indicators comprises a first key performance indicator that does not satisfy a first specific predetermined acceptance criteria and a second key performance indicator that does not satisfy a second specific predetermined acceptance criteria.

7. A method, comprising:
evaluating a set of data from a process control system;
determining how to configure a graphical user interface based, at least in part, on the evaluation; and
creating the graphical user interface according to the determined configuration, where the graphical user interface visually presents information indicative of a performance of the process control system.

8. The method of claim 7, where the graphical user interface presents a key performance indicator for the process control system.

9. The method of claim 8, where the graphical user interface presents an initial classification of the key performance indicator, where the initial classification is based, at least in part, on performance of an entity upon which the key performance indicator represents, and where the initial classification is user modifiable.

10. The method of claim 7, where the graphical user interface comprises a spider chart.

11. The method of claim 7, comprising:
causing the graphical user interface to be presented on a display screen.

12. The method of claim 7, where the graphical user interface is configured to mimic a topology of the process control system in a hierarchical manner.

13. The method of claim 7, comprising:
determining data from the set of data that is considered high priority based, at least in part, on the evaluation result, where the graphical user interface is configured to highlight data considered high priority.

14. The method of claim 7, where the graphical user interface simultaneously presents a first trend plot and a second trend plot.

15. The method of claim 7, where the graphical user interface is modifiable by creating a custom grouping of entities of the process control system and where the modified graphical user interface presents key performance indicators of individual entities of the custom grouping.

16. The method of claim 7, where the graphical user interface comprises a trend plot and where the trend plot plots a first variable against a second variable.

17. The method of claim 7, where the graphical user interface is used to perform analysis upon the process control system.

18. A system, comprising:
a identification component configured to identify a set of key performance indicators indicative of performance of a process control system that do not meet a desired result;
a determination component configured to determine a priority level order for individual key performance indicators of the set of key performance indicators;
a generation component configured to generate a graphical user interface, where the graphical user interface indicates individual key performance indicators of the set of key performance indicators according to the priority level order and where the graphical user interface indicates a performance level of an individual key performance indicator; and
a manual override component configured to enable a manual modification of the graphical user interface such that performance level of the individual key performance indicator is changed.

19. The system of claim 18, where the performance level is changed from an acceptable performance level to an unacceptable performance level.

20. The system of claim 18, where the performance level is changed from an unacceptable performance level to an acceptable performance level.
